(19) United States
(12) Patent Application Publication
(10) Pub. No.: US 2017/0106603 A1
(43) Pub. Date: Apr. 20, 2017

(54) THREE DIMENSIONAL PRINTER

(71) Applicant: SGAT PTY LTD, Canberra (AU)

(72) Inventor: Scott POBIHUN, Farrer (AU)

(21) Appl. No.: 15/124,249

(22) PCT Filed: Mar. 6, 2015
(86) PCT No.: PCT/AU2015/050091

§ 371 Date: Sep. 7, 2016

(30) Foreign Application Priority Data
Mar. 7, 2014 (AU) 2014900786
Jun. 24, 2014 (AU) 2014902414

(51) Int. Cl. B29C 67/00; B33Y 70/00; B33Y 10/00; B33Y 40/00; B33Y 30/00; B33Y 50/02

(52) U.S. Cl. CPC B29C 67/0092; B33Y 30/00; B33Y 50/02; B33Y 10/00; B33Y 40/00; B29C 67/0066; B33Y 70/00; B29C 67/0088

(57) ABSTRACT

Disclosed is a three-dimensional printer and a method of operating the same. In one aspect the three dimensional printer (400) includes a first vessel (140) in fluid communication with a second vessel (130); a pressure altering device (350); a light source (380); and a controller (300) configured to: control the light source (380) to generate light directed toward a production medium (210) supported by a support medium (200) located within the first vessel to cure a portion of the production medium (230); and control the pressure altering device (350) to induce a flow of support medium (200) between the first and second vessels (140), (130) such as to raise or lower the support medium (200) within the first vessel (140) to enable generation of layers of the cured production medium (230).

### CROSS-REFERENCE TO RELATED APPLICATIONS

The present application claims priority from Australian Provisional Patent Application No. 2014900786 filed on 7 Mar. 2014 and Australian Provisional Patent Application No. 2014902414 filed 24 Jun. 2014, the contents of which is incorporated herein by reference.

### FIELD OF INVENTION

The present invention relates to a three-dimensional printer and a method of operating the same.

### BACKGROUND

A number of techniques are utilised by three-dimensional printers for printing a three dimensional object. One technique includes additive manufacturing where layers of an object are generated by curing a photo-reactive resin with a UV laser or another similar power source. For each layer, a laser beam traces a cross-section of a pattern on a surface of liquid resin. Exposure to the ultraviolet laser light cures and solidifies the pattern traced on the resin and joins it to the layer below. After the pattern has been traced, an elevator platform descends by a distance equal to the thickness of a single layer which can range between 0.05 mm to 0.15 mm. The subsequent layer pattern is traced into the surface of the liquid resin, joining the previous layer.

It will be appreciated that due to the small distance which the elevator platform descends between each layer, sophisticated arrangements are required, such as highly accurate stepper motors and the like. Amongst other reasons, this can result in three-dimensional printers being quite expensive.

There is therefore a need to alleviate one or more of the above mentioned problems or to provide a useful commercial alternative.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

In a first aspect there is provided a three-dimensional printer including:

a first vessel in fluid communication with a second vessel;

a pressure altering device;

a light source; and

a controller configured to:
control the light source to generate light directed toward a production medium supported by a support medium located within the first vessel to cure a portion of the production medium; and
control the pressure altering device to induce a flow of support medium between the first and second vessels such as to raise or lower the support medium within the first vessel to enable generation of layers of the cured production medium.

In certain embodiments, the pressure altering component is an electronically controllable valve to control a control medium entering or exiting the second vessel.

In certain embodiments, at least one of:

the control medium is air; and

the support medium is saline.

In certain embodiments, the three-dimensional printer includes a first pressure sensor for sensing the pressure within the second vessel, wherein the controller controls the pressure altering device based on feedback received from the first pressure sensor.

In certain embodiments, the three-dimensional printer includes a sealable lid which is movable between an open position and a closed position to seal an open top of the first vessel.

In certain embodiments, the three-dimensional printer includes:

a housing including a lid, wherein the housing is configured to house the light source and the first vessel; and

a lid sensor to detect whether the lid is placed in the open or closed position, wherein the controller controls the light source based upon the lid being detected in the closed position.

In certain embodiments, the three-dimensional printer includes a mixer controllable by the controller to mix the support medium.

In certain embodiments, the three-dimensional printer includes a mixing module, separate to the first and second vessel, which receives a first component of the support medium and contains a second component of the support medium, wherein the mixing module includes the mixer which mixes the first and second components to produce the support medium, wherein the support medium is supplied to at least one of the first and second vessels.

In certain embodiments, the light source includes a laser assembly including:

a laser device operably connected to the controller for generating the light in the form of a laser;

a galvanometer assembly operably connected to the controller; and

a plurality of mirrors coupled to the galvanometer assembly, wherein an orientation of the mirrors are controllable by the controller via actuation of the galvanometer assembly to control a location which the laser is directed toward the production medium.

In certain embodiments, the controller is configured to control the galvanometer assembly based on a height of the cured production medium within the first vessel.

In certain embodiments, the controller is configured to:

receive audio data; and

control the laser assembly according to the audio data.

In certain embodiments, the audio data is indicative of music.

In certain embodiments, the light source is:

a digital light projector; or

a light emitting diode system.

In certain embodiments, the three-dimensional printer includes:

a temperature sensor, in communication with the controller, for sensing the temperature within at least one of the first and second vessel; and

a heating element, wherein the controller is configured to control the heating element based on a temperature feedback signal received from the temperature sensor.

In certain embodiments, the three-dimensional printer includes a build platform located within the first vessel, wherein the build platform is configured to support the cured production medium within the first vessel.

In certain embodiments, the controller is configured to control the light source to generate:

a first light having a frequency for curing at least a portion of the production medium; and

a second light having a second frequency which does not cure the production medium, wherein the second light is directed toward the cured production medium to control a position of the cured production medium within the first vessel.

In certain embodiments, the three-dimensional printer includes a film which is operably connected to the controller, wherein actuation of the film by the controller inhibits external light entering the first vessel.

In certain embodiments, the three-dimensional printer includes a tank, wherein the first vessel is a first chamber of the tank and the second vessel is a second chamber of the tank, wherein the first and second chambers are defined within the tank via a partition, wherein the partition includes an aperture to allow the flow of support medium between the first and second vessels.

In certain embodiments, the three-dimensional printer includes a plurality of partitions having a plurality of apertures, wherein the plurality of apertures enable a multidirectional flow of support medium between the first and second chambers.

In certain embodiments, each aperture is located near a base portion of the respective partition.

In certain embodiments, the three-dimensional printer includes:

a third vessel in fluid communication with the second vessel; and

an additional pressure altering device controllable by the controller to induce a flow of control medium into the third vessel such that the production medium is lowered within the first vessel.

In certain embodiments, the three-dimensional printer includes a base portion of at least one wall of the second vessel includes at least one aperture to allow the flow of the control medium into the third vessel from the second vessel.

In certain embodiments, the controller is configured to:

control the light source to cure a layer of the production medium, wherein the first layer protrudes above the production medium supported upon the support medium;

control the pressure altering device to coat the cured layer of the production medium with the production medium supported by the support medium; and then

control the additional pressure altering device to lower the supported production medium for curing the next layer.

In certain embodiments, the pressure altering device is a drip feed assembly for dripping the support medium into the second vessel causing the production medium to rise within the first vessel.

In certain embodiments, the first pressure altering device is a source of inert gas, wherein the controller is configured to control the pressure altering device to supply at least some of the inert gas to the second vessel causing the production medium to rise within the first vessel.

In certain embodiments, the three-dimensional printer includes one or more vacuum devices.

In certain embodiments, at least some of the one or more vacuum devices are in fluid communication with the second vessel, wherein the controller is configured to control the at least some of the one or more vacuum devices causing the support medium to rise within the second vessel.

In certain embodiments, at least some of the one or more vacuum devices are in fluid communication with an additional vessel which in turn is in fluid communication with the first vessel via a valve operably connected to the controller, wherein the controller is configured to actuate the valve and the at least some of the vacuum devices to induce the flow of the support medium, wherein an amount of the control medium is extracted from the first vessel and contained within the additional vessel.

In certain embodiments, the three-dimensional printer includes an exhaust assembly and filter for expelling gas or vapour from the first vessel.

In certain embodiments, the light source includes:

a displacement assembly operably controllable by the controller; and

a light emitting device operably connected to the controller and mounted to the displacement assembly;

wherein the controller is configured to actuate the displacement assembly causing the light emitting device to be displaced in one or more dimensions.

In certain embodiments, the three dimensional printer includes a further vessel having a pressurised supply of control medium contained therein and in fluid communication with the second vessel via a valve operably connected to the controller, wherein the controller is configured to actuate the valve to induce the flow of the support medium.

In certain embodiments, the three dimensional printer includes:

a barometer for measuring the pressure within the further vessel which provides a feedback signal to the controller indicative of the sensed pressure; and

a pump in fluid communication with the further vessel, wherein the controller electrically controls the pump to cause a flow of additional control medium within the further vessel based on the sensed pressure.

In certain embodiments, at least one of the vessels include an emptying valve to allow one or more of the vessels to be emptied.

In certain embodiments, the controller is configured to control an intensity of the light emitted by the light source.

In a second aspect there is provided a method of operating a three dimensional printer according to the first aspect, wherein the method includes:

partially filling the first and second vessels with a support medium;

adding the production medium to the first vessel which is supported by the support medium;

sealing the first vessel;

filling the second vessel with more support medium;

unsealing the first vessel; and

instructing the controller to control the flow of the support medium between the first and second vessels.

In certain embodiments, prior to instructing the controller, the method includes flushing air from the first vessel, wherein the air is replaced with an inert gas which is not air.

In a third aspect there is provided a method of operating a three dimensional printer according embodiments including a third vessel, wherein the method includes:

partially filling the first and second vessels with fluid whilst the third vessel is sealed;

adding the production medium to the first vessel which is supported by the support medium;

sealing the first vessel;

filling the second vessel with more support medium;

unsealing the first vessel; and

instructing the controller to:
control the flow of the support medium between the first and second chamber to raise the production medium in the first vessel; and
control the flow of the support medium to the third vessel to lower the production medium in the first vessel.

In certain embodiments, prior to instructing the controller, the method includes flushing air from the first and third vessels, wherein the air is replaced with an inert gas which is not air.

In certain embodiments of the second and third aspects, once the pressure within first vessel is substantially equal to atmospheric pressure and prior to completing a printing job, the method includes:

resealing the first vessel;

filling the second vessel with more support medium;

unsealing the first vessel; and

instructing the controller to control the flow of the fluid between the first and second vessels.

In certain embodiments, the support medium is saline.

In a fourth aspect there is provided a three-dimensional printer including:

a first vessel in fluid communication with a second vessel;

a pressure altering device;

a light source; and

a controller configured to:
control the light source to generate light directed toward a production medium contained within the first vessel to cure a portion of the production medium; and
control the pressure altering device to raise or lower the production medium within the first vessel to enable generation of layers of the cured production medium.

In certain embodiments, the pressure altering component is an electronically controllable valve to control a control medium entering or exiting the second vessel.

In certain embodiments, the control medium is air.

In certain embodiments, the three-dimensional printer includes a first pressure sensor for sensing the pressure within the second vessel, wherein the controller controls the pressure altering device based on feedback received from the first pressure sensor.

In certain embodiments, the three-dimensional printer includes a sealable lid which is movable between an open position and a closed position to seal an open top of the first vessel.

In certain embodiments, the three-dimensional printer includes:

a housing including a lid, wherein the housing is configured to house the light source and the first vessel; and

a lid sensor to detect whether the lid is placed in the open or closed position, wherein the controller controls the light source based upon the lid being detected in the closed position.

In certain embodiments, the light source includes a laser assembly including:

a laser device operably connected to the controller for generating the light in the form of a laser;

a galvanometer assembly operably connected to the controller; and

a plurality of mirrors coupled to the galvanometer assembly, wherein an orientation of the mirrors are controllable by the controller via actuation of the galvanometer assembly to control a location which the laser is directed toward the production medium.

In certain embodiments, the controller is configured to control the galvanometer assembly based on a height of the cured production medium within the first vessel.

In certain embodiments, the controller is configured to:

receive audio data; and

control the laser assembly according to the audio data.

In certain embodiments, the audio data is indicative of music.

In certain embodiments, the light source is:

a digital light projector; or

a light emitting diode system.

In certain embodiments, the three-dimensional printer includes:

a temperature sensor, in communication with the controller, for sensing the temperature within at least one of the first and second vessel; and

a heating element, wherein the controller is configured to control the heating element based on a temperature feedback signal received from the temperature sensor.

In certain embodiments, the three-dimensional printer includes a build platform located within the first vessel, wherein the build platform is configured to support the cured production medium within the first vessel.

In certain embodiments, the controller is configured to control the light source to generate:

a first light having a frequency for curing at least a portion of the production medium; and

a second light having a second frequency which does not cure the production medium, wherein the second light is directed toward the cured production medium to control a position of the cured production medium within the first vessel.

In certain embodiments, the three-dimensional printer includes a film which is operably connected to the controller, wherein actuation of the film by the controller inhibits external light entering the first vessel.

In certain embodiments, the three-dimensional printer includes a tank, wherein the first vessel is a first chamber of the tank and the second vessel is a second chamber of the tank, wherein the first and second chambers are defined within the tank via a partition, wherein the partition includes an aperture to allow the flow of production medium between the first and second vessels.

In certain embodiments, the three-dimensional printer includes a plurality of partitions having a plurality of apertures, wherein the plurality of apertures enable a multidirectional flow of production medium between the first and second chambers.

In certain embodiments, each aperture is located near a base portion of the respective partition.

In certain embodiments, the three-dimensional printer includes:

a third vessel in fluid communication with the second vessel; and

an additional pressure altering device controllable by the controller to induce a flow of control medium into the third vessel such that the production medium is lowered within the first vessel.

In certain embodiments, the three-dimensional printer includes a base portion of at least one wall of the second vessel includes at least one aperture to allow the flow of the control medium into the third vessel from the second vessel.

In certain embodiments, the controller is configured to:

control the light source to cure a layer of the production medium, wherein the first layer protrudes above the production medium;

control the pressure altering device to coat the cured layer of the production medium with the production medium; and then

control the additional pressure altering device to lower the cured production medium for curing the next layer.

In certain embodiments, the pressure altering device is a drip feed assembly for dripping the production medium into the second vessel causing the production medium to rise within the first vessel.

In certain embodiments, the first pressure altering device is a source of inert gas, wherein the controller is configured to control the pressure altering device to supply at least some of the inert gas to the second vessel causing the production medium to rise within the first vessel.

In certain embodiments, the three-dimensional printer includes one or more vacuum devices.

In certain embodiments, at least some of the one or more vacuum devices are in fluid communication with the second vessel, wherein the controller is configured to control the at least some of the one or more vacuum devices causing the production medium to rise within the second vessel.

In certain embodiments, at least some of the one or more vacuum devices are in fluid communication with an additional vessel which in turn is in fluid communication with the first vessel via a valve operably connected to the controller, wherein the controller is configured to actuate the valve and the at least some of the vacuum devices to induce the flow of the production medium, wherein an amount of the control medium is extracted from the first vessel and contained within the additional vessel.

In certain embodiments, the three-dimensional printer includes an exhaust assembly and filter for expelling gas or vapour from the first vessel.

In certain embodiments, the light source includes:

a displacement assembly operably controllable by the controller; and

a light emitting device operably connected to the controller and mounted to the displacement assembly;

wherein the controller is configured to actuate the displacement assembly causing the light emitting device to be displaced in one or more dimensions.

In certain embodiments, the three dimensional printer includes a further vessel having a pressurised supply of control medium contained therein and in fluid communication with the second vessel via a valve operably connected to the controller, wherein the controller is configured to actuate the valve to induce the flow of the production medium.

In certain embodiments, the three dimensional printer includes:

a barometer for measuring the pressure within the further vessel which provides a feedback signal to the controller indicative of the sensed pressure; and

a pump in fluid communication with the further vessel, wherein the controller electrically controls the pump to cause a flow of additional control medium within the further vessel based on the sensed pressure.

In certain embodiments, at least one of the vessels include an emptying valve to allow one or more of the vessels to be emptied.

In certain embodiments, the controller is configured to control an intensity of the light emitted by the light source.

In another aspect there is provided a three-dimensional printer including:

a vessel;

a pressure altering device;

a light source; and

a controller configured to:
control the light source to generate light directed toward a production medium located within the vessel to cure a portion of the production medium; and
control the pressure altering device to raise or lower the support medium within the first vessel to enable generation of layers of the cured production medium.

In a sixth aspect there is provided a three-dimensional printer including:

a first vessel in communication with a second vessel via a passage, wherein a flowable support medium is contained within the first and second vessel;

a pressure altering device;

a light source; and

a controller configured to:
control the light source to generate light directed toward a flowable production medium supported upon the support medium located within the first vessel to cure a portion of the production medium; and
control the pressure altering device to pressurise the second vessel, thereby causing a flow of support medium between the second vessel and the first vessel enabling generation of cured layers of the production medium.

Other aspects and embodiments will be appreciated throughout the description.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 is an isometric view of an example of a tank of a three-dimensional printer including a first and second chamber;

FIGS. 2A to 2F are a series of cross-sectional views of the tank of the three-dimensional printer of FIG. 1 during setup and operation;

FIG. 3 is a functional block diagram of an example controller electrically connected to components of the three-dimensional printer of FIG. 1;

FIG. 4 is a perspective view of another example of the three-dimensional printer including a first, second and third chamber;

FIG. 5A is a perspective view of the tank of the three-dimensional printer of FIG. 4;

FIG. 5B is a isometric view of the tank of the three-dimensional printer of FIG. 4;

FIGS. 6A to 6G are a series of cross-sectional views of the tank of the three-dimensional printer of FIG. 4 during setup and operation;

FIG. 7 is a functional block diagram of an example controller electrically connected to components of the three-dimensional printer of FIG. 4;

FIG. 8 is an isometric view of a further example of a tank for a three-dimensional printer;

FIGS. 9A to 9D are a series of cross-sectional views of the tank of the three-dimensional printer of FIG. 1 for flushing air from the tank;

FIGS. 10A to 10D are a series of cross-sectional views of the tank of the three-dimensional printer of FIG. 1 for printing an object by refilling the second chamber;

FIGS. 11A to 11D are a series of cross-sectional views of the tank of the three-dimensional printer of FIG. 1 for printing an object by connecting a pressurised gas source to the second chamber during the printing job;

FIG. 12 illustrates a cross-sectional view of the tank of FIG. 1 including curved corners; and

FIGS. 13A to 13D illustrate a series of cross-sectional views of the tank of the three-dimensional printer of FIG. 4 for refilling the second chamber after a state of equilibrium has been reached;

FIGS. 14A shows a front view of an example of a three-dimensional printer with the lid in a closed position;

FIG. 14B shows a front view of the three-dimensional printer of FIG. 14A with the lid in the open position;

FIG. 14C shows a rotated view of the front and side views of the three-dimensional printer of FIG. 14C with the lid in the open position;

FIG. 14D shows a rear view of the three-dimensional printer of FIG. 14A with the lid in the open position;

FIG. 15 shows a schematic of a control system for an additional chamber of the three dimensional printer; and

FIG. 16 is a schematic isometric view of the three dimensional printer including first and second additional chambers;

FIG. 17 is a schematic isometric view of an example of a housing for a three-dimensional printer;

FIG. 18 is a schematic of another example of a housing for a three dimensional printer including a light emitting module mounted to the base section of the housing;

FIG. 19 is a schematic of another example of a housing for a three dimensional printer including a light emitting module mounted to the lid section of the housing.

### DETAILED DESCRIPTION OF THE PREFERRED EMBODIMENTS

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

In certain aspects there is disclosed a three-dimensional printer 400. In particular embodiments, the three dimensional printer includes a vessel assembly 101, a pressure altering device 350, an energy source such as a light source 380, and a controller 300. The controller 300 is configured to control the light source 380 to generate light directed toward a production medium 210 located within the vessel assembly 101 to cure a portion of the production medium 210. The controller 300 is also configured to control a pressure altering device 350 to cause the production medium 210 within the vessel 140 be to be raised or lowered such as to enable the generation of layers of the cured production medium 210.

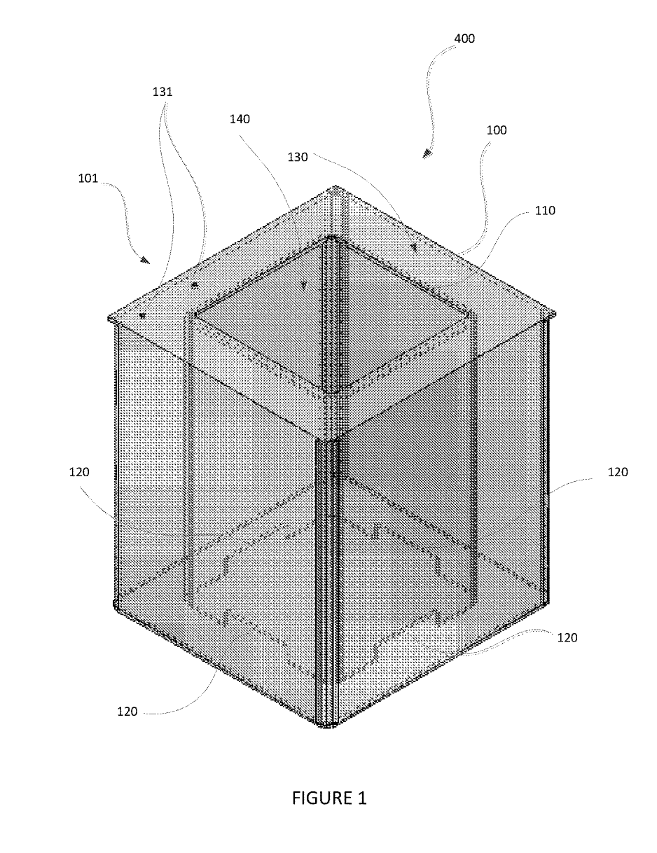

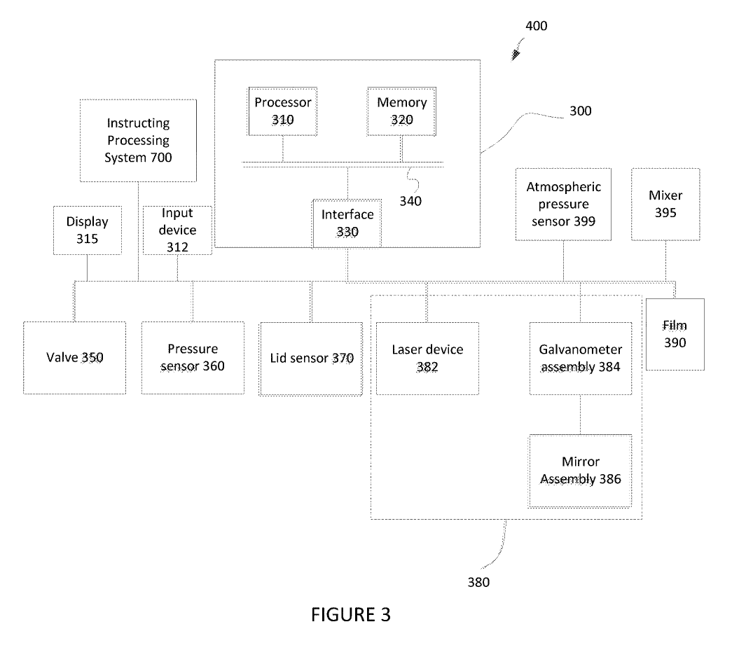

Referring more specifically to FIG. 1, there is shown an example of a tank 100 of the three dimensional printer 400. The tank 100 can be provided in the form of a vat. FIG. 3 also shows a functional block diagram of the controller 300 of the three-dimensional printer 400 depicted in FIG. 1 and components thereof that are electrically connected to the controller 300. As shown in FIG. 1, the three-dimensional printer 400 includes a first vessel 140 and a second vessel 130. The first and second vessels 140, 130 are in communication via a passage 120.

The first and second vessels 140, 130 are defined within the tank 100 including at least one partition 110, wherein the first vessel 140 is defined as a first chamber 140 and the second vessel 130 is defined as a second chamber 130. In particular, four upstanding walls located within the tank 100 define the first and second chamber 140, 130. Specifically, the space between the walls of the tank 100 and the partition walls define the second chamber 130, and the space located internally of the partition walls define the first chamber 140. In this example, the first chamber 140 is surrounded by the second chamber 130 within the tank 100 in a nested arrangement.

The first and second chambers 140, 130 are configured for holding a support medium 200 which in this example is saline. It will be appreciated that other forms of support medium 200 can be used which have a density which is greater than a density of the production medium. The first chamber 140 is in communication with the second chamber 130 via an interface such the passage 120 provided in the form of an aperture in the partition walls. In this example, the aperture 120 is located near a base portion of each partition 110 adjacent the base wall of the tank 100. Each aperture 120 can have a slot profile. Each aperture 120 allows for a flow of support medium 200 between the second chamber 130 and the first chamber 140. It will be appreciated that the arrangement of partitions 110 enables the flow of the support medium 200 between the second and first chamber 140, 130 to be multidirectional into the first chamber 140.

The first chamber 140 has an open top that can be sealed using a lid 220. As will be discussed later herein, the lid 220 can be opened and closed in particular steps to setup and/or operate the three-dimensional printer 400 for a printing job.

The second chamber 130 includes one or more ports 131. The one or more ports 131 enable the second chamber 130 to be filled with the support medium 200 and also enables air to flow into or out of the second chamber 130. When the second chamber 130 contains the support medium 200 covering the apertures 120 and the one or more ports are closed, the second chamber 130 is effectively sealed from the external environment.

In addition to the first and second chambers 130, 140 being configured to hold an amount of the support medium 200, an amount of the production medium 210 provided in the form of a curable substance, such as a photosensitive resin, is contained within the first chamber 140 which is supported upon the upper surface of the support medium 200. Specifically, the production medium 210 has a lesser density than the support medium 200. The production medium 210 can be added to the first chamber 140 via the open top so that it is supported upon the surface of support medium 200 contained in the first chamber 140.

The first pressure-altering device 350 is configured to pressurise the second vessel 130 and the first vessel 140 to displace at least some of the support medium and induce the flow of the support medium 200 between the second and first chambers 130, 140 via the apertures 120. In this example, the first pressure-altering device 350 is a valve that is operably controllable by the controller 300. When the valve 350 is actuated to allow a control medium 99, such as air, to enter into the second chamber 130, some of the support medium 200 contained in the second chamber 130 flows 290 into the first chamber 140 via the apertures 120 provided by the partitions 110 such that the level of the production medium 210 supported upon the support medium 200 in the first chamber 140 rises.

The tank 100 can also include a build platform 150 which is located within the first chamber 140 and is generally releasably fixed to the three-dimensional printer 400 such that when the level of the production medium 210 rises or falls, the build platform 150 remains stationary within the first chamber 140. In one form, the build platform 150 is releasably mounted to or within the first chamber 140. The build platform 150 includes a support surface forming a mesh to enable the support medium 200 and the production medium 210 to flow through the mesh. The build platform 150 enables a portion of the production medium 210 to initially cure to the mesh when the controller 300 operates the light source 380. Thus, when the level of the production medium 210 within the first chamber 140 rises, layers of the cured production medium 230 remain stationary within the first chamber 140 due to being attached to the build platform 150. The supported production medium 210 rises above generated layers which have been cured due to the actuation of the pressure altering device 350 causing the flow of the support medium into the first chamber 140, thereby enabling further layers to be cured. This arrangement thereby allows fine control of the layer thickness of the generated object 230 via pressure control.

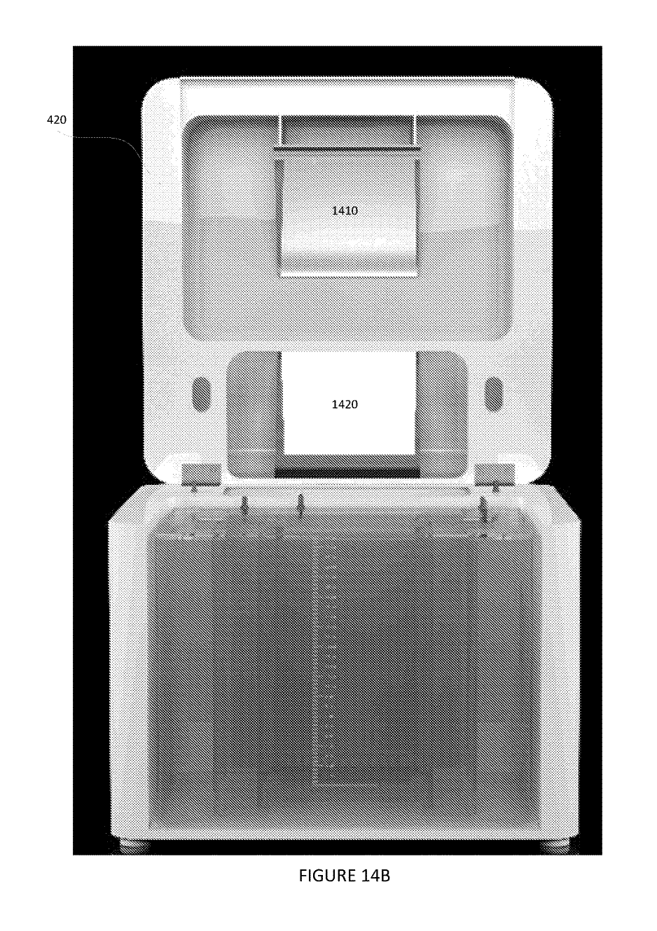

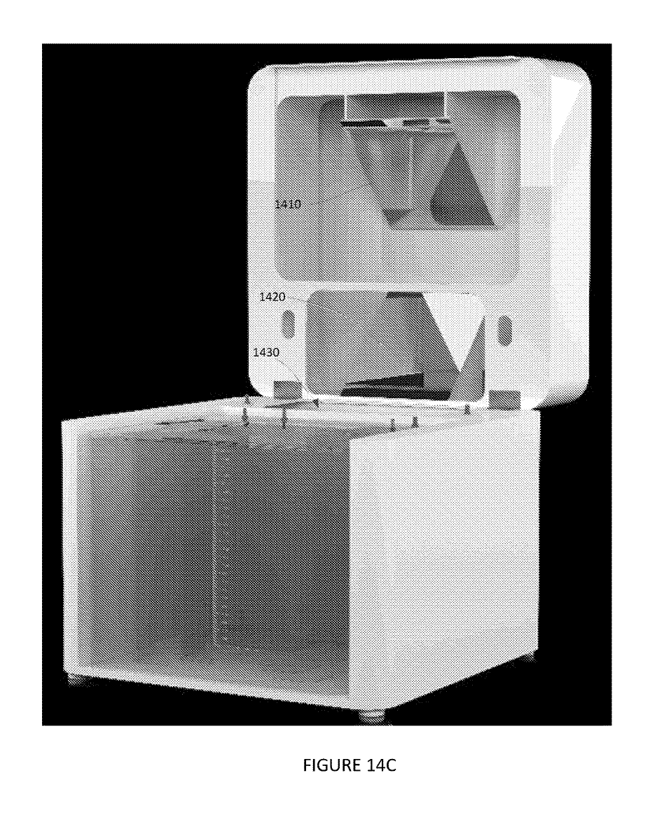

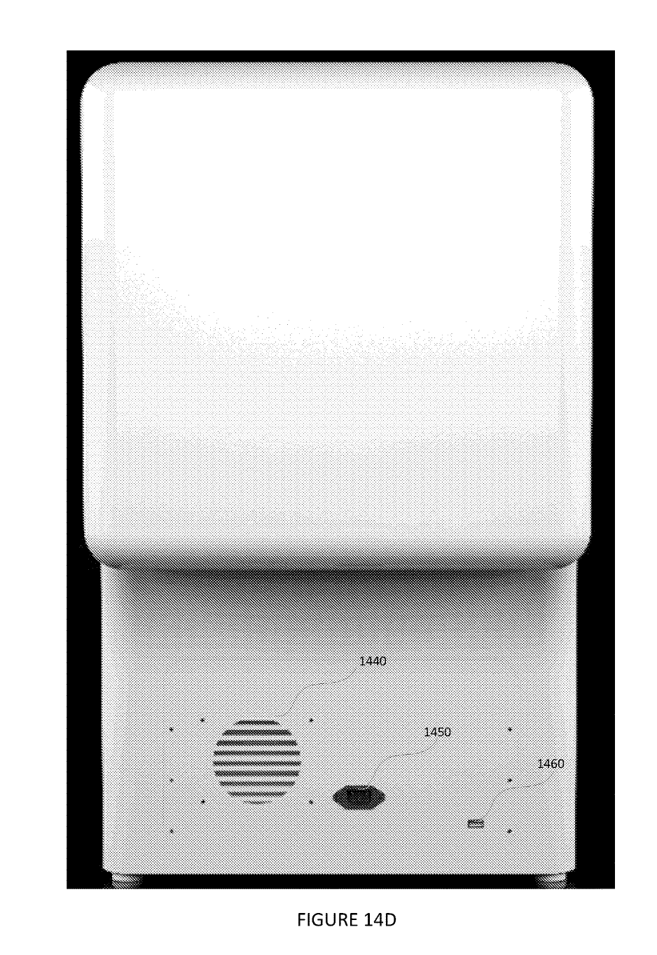

The controller 300 is electrically connected to the pressure altering device 350 and also the light source 380. The controller 300 is generally provided in the form of a microcontroller 300 including a processor 310, a memory 320, and an interface 330 connected together via a bus 340. In some forms, the controller 350 can include or is operably connected to an output device such as a display 315 and an input device 312 such as a keypad. The input and output devices 312, 315 can be provided in the form of a touch screen interface. The interface 330 of the microcontroller 300 is electrically connected to the pressure altering device 350 and the light source 380. The interface 330 can also be connected to an instructing processing system 700 via port 1460 (see FIG. 14D) that transfers executable or interpretable print instructions to the controller 300. The print instructions can be stored in a volatile or non-volatile manner in the memory 320. The controller receives electrical power via an electrical power supply connected via electrical port 1450 (see FIG. 14D). The processor 310 controls the light source 380 in accordance with the print instructions to generate a light 383 directed toward the production medium 210 supported upon the support medium 200 within the first chamber 140 to cure a portion of the production medium 210. Furthermore the processor 310 is configured to control the pressure altering device 350 to raise the curable substance 210 within the first chamber 140 to enable generation of layers of the cured production medium 230.

Due to the controller 300 being able to electrically control the pressurization of the second vessel 140 and thus create a pressure differential between the first and second vessels 140, 130 and across the one or more apertures 120. As such that the second vessel a flow 290 of at least some of the support medium 200 is induced through the apertures 120 of the partitions 110 to the first vessel 140. This thereby provides the three dimensional printer 400 with a fine level of control of the layer thickness of the generated three dimensional object 230 with minimal mechanical parts. This therefore enables the provision of the three dimensional printer 400 which can be reasonably priced compared to other three-dimensional printers which include stepper motors or the like to provide z-axis control of the manufacturing process. Furthermore, due to the flow 290 of the support medium 200 through the apertures 120 located proximal to the base of the partitions 110, minimal disturbances occur to the upper surface of the production medium 210, thereby increasing the quality of the printed 3D objects 230. Propagation of disturbances from the second chamber 130 to the first chamber 140 can be minimised due to the use of the separate vessels and/or partitioned tank 100, thereby enabling the generation of higher quality three-dimensional objects 230. Furthermore, the three dimensional printer 400 is very quiet. Additionally, the three dimensional printer 400 can produce a three dimensional object quickly due to the ability to finely adjust layer heights quickly.

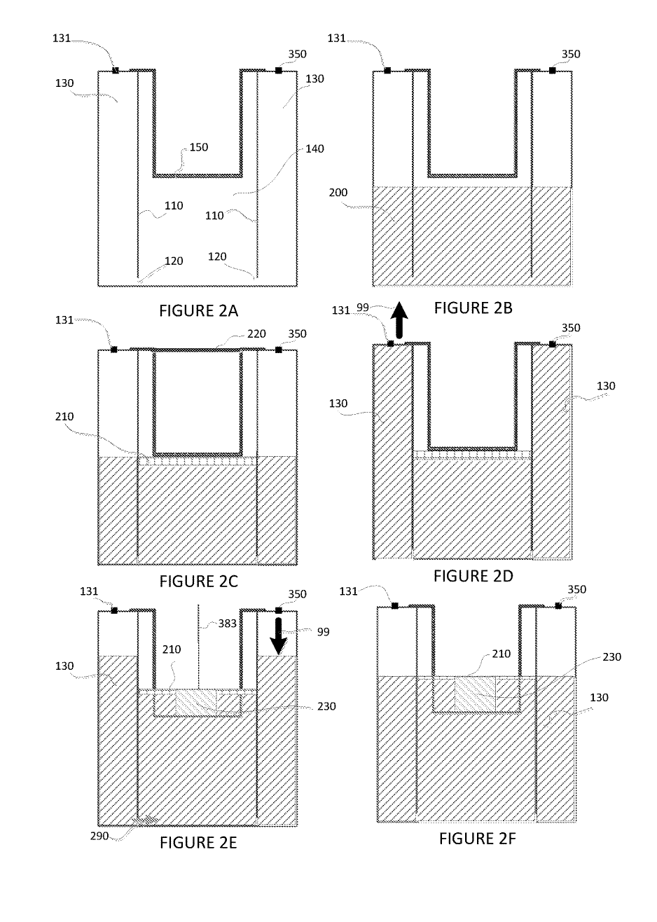

Referring to FIG. 2A to 2F there is shown a series of cross-sectional views of the tank 100 during steps for setting up and operating the three dimensional printer 400 as discussed in relation to FIGS. 1 to 3. FIG. 2A shows the tank 100 in the empty state. As shown in FIG. 2B, a support medium 200 is input via an open top of the first chamber 140, thereby partially filling the first chamber 140 as well as the second chamber 130 via the one or more apertures 120 in the partitions 110. The tank 100 is partially filled until the upper surface of the support medium 200 has at least covered the apertures 120. At this point, the level of the support medium 200 in the first chamber 140 and second chamber 130 is equal, thus the pressure in each chamber is in equilibrium.

As shown in FIG. 2C, the production medium 210 is provided into the first chamber 140. The support medium 200 has a greater density than the production medium 210 such that the production medium 210 is supported on the surface of the supported medium 200 contained in the first chamber 140. The production 210 is provided within the first chamber 140 until the upper surface of the production medium 210 is adjacent the underside of the build platform 150. Alternatively, the build platform 150 may be telescopically adjustable such that it is adjusted to be substantially adjacent the upper surface of the production medium 210.

The first chamber 140 is then sealed using the lid 220, thus no control medium 99, such as air, can enter or exit the first chamber 140. Then, as shown in FIG. 2D, further support medium 200 is provided within the second chamber 130 via the one or more ports 131. Due to the sealing of the first chamber 140 via the lid 220, no support medium 200 flows from the second chamber 130 into the first chamber 140 via the apertures 120 in the partitions 110. The second chamber 130 can continue to be filled until a sufficient amount of additional support medium 200 is contained in the second chamber 130 or the second chamber 130 is full. Then the one or more ports 131 of the second chamber 130 are sealed and the lid 220 is then unsealed as shown in FIG. 2D.

Due to the second chamber 130 being sealed, no support medium 200 flows from the second chamber 130 to the first chamber 140 despite the level of the support medium 200 in the second chamber 130 being higher than the level of the support medium 200 in the first chamber 140. At this point, the tank 100 of three dimensional printer 400 has been setup and ready for printing a three dimensional object 230.

As shown in FIG. 2E, when the printing commences, the controller 300 controls the light source 380 (see FIG. 3) to generate light 383 which is directed toward the production medium 210 to cure a first layer to the build platform 150. Next the controller 300 controls actuation of the valve 350 to allow for the control medium 99, such as air, to enter the second chamber 130 in a controlled manner. This causes some of the support medium 200 contained in the second chamber 130 to flow 290 from the second chamber 130 to the first chamber 140 via the apertures 120 in the partitions 110, thereby raising the upper level of the production medium 210 supported on top of the support medium 200 contained in the first chamber 140. The controller 300 controls the amount and flow rate of control medium 99 entering the second chamber 130 such that the supported production medium 210 is raised within the first chamber 140 a distance equal to a layer of the three dimensional object 230 to be generated.

Once the level of the production medium 210 has been sufficiently raised, the controller 300 actuates the valve 350 such that it closes and reseals the second chamber 130. The controller 300 then controls the light source 380 to generate the light 383 to generate the second layer of the three dimensional object upon the cured production medium 230 attached to the build platform 150. Once the second layer has been cured, the process is repeated by controlling the valve 350 of the second chamber 130 to allow for a flow 290 of support medium 200 into the first chamber 140, thereby raising the level of the production medium 210 in the first chamber 140 by the distance of another layer, resealing the second chamber 130, and then controlling the light source 380 to generate the next layer.

Once the printing job is complete, as shown in FIG. 2F, the build platform 150 can be removed from the first chamber 140 and the three dimensional object 230 can be detached from the build platform 150. In the event that the pressure within the second chamber 130 is equal to atmospheric pressure and the printing job has yet to be completed, the second chamber 130 can be refilled with further support medium 200. Specifically, the controller 300 can be in communication with an atmospheric sensor 399 pressure (see FIG. 3) provided in the form of a barometric sensor for sensing the atmospheric pressure, or the controller can sense the pressure whilst the tank 100 is empty using a pressure sensor 360 of the second chamber, wherein the controller 300 compares the pressure within the second chamber 130 against sensed atmospheric pressure to determine if the two pressures are substantially equal. In the event that they are substantially equal, the first chamber 140 is once again resealed, the second chamber 130 is provided with further support medium 200 via the port 131, the second chamber 130 is resealed once a sufficient amount of support medium 200 has been provided into the second chamber 130 or it is full, and the first chamber 140 is unsealed. It will be appreciated that the operator may determine whether a sufficient amount of support medium 200 has been provided, although this could alternatively be an automated process where operator intervention is not required. The controller 300 can then begin controlling the valve 350 to enable further layers of production medium 210 to be cured by controlling the light source 380 to complete the printing job.

Referring more specifically to FIG. 3, the three dimensional printer 400 can include a pressure sensor 360 in the form of a barometric sensor to sense the pressure within the second chamber 130. The pressure sensor 360 is in electrical communication with the controller 300 to provide a feedback signal indicative of the pressure within the second chamber 130. As the controller 300 controls the opening of the valve 350 to cause the production medium 210 to rise in the first chamber 140, the pressure sensor 360 transfers a feedback signal indicative of the pressure experienced within the second chamber 130 back to the controller 300 as part of a feedback system. When the feedback signal indicates a change in pressure within the second chamber 130 has been reached which is indicative of the production medium 210 having risen the distance of a layer for the three dimensional object 230, the controller 300 can close the valve 350. The change in pressure which is indicative of a distance between each layer can be stored in memory of the controller 300. In one form, the distance may be predefined, alternatively the distance may be defined by the received print instructions stored in memory 320. The change in pressure may be received by the controller 300 from the instructing processing system 700.

In certain embodiments, the three dimensional printer 400 includes a lid sensor 370 to detect whether the lid 420 of a housing 410 that houses the tank 100 is placed in the open or closed position. The lid sensor 370 is electrically connected to the controller 300 to receive a feedback signal indicative of the position of the lid 420. The controller 300 is configured to performing the printing process based upon the detected closed position of the lid 420.

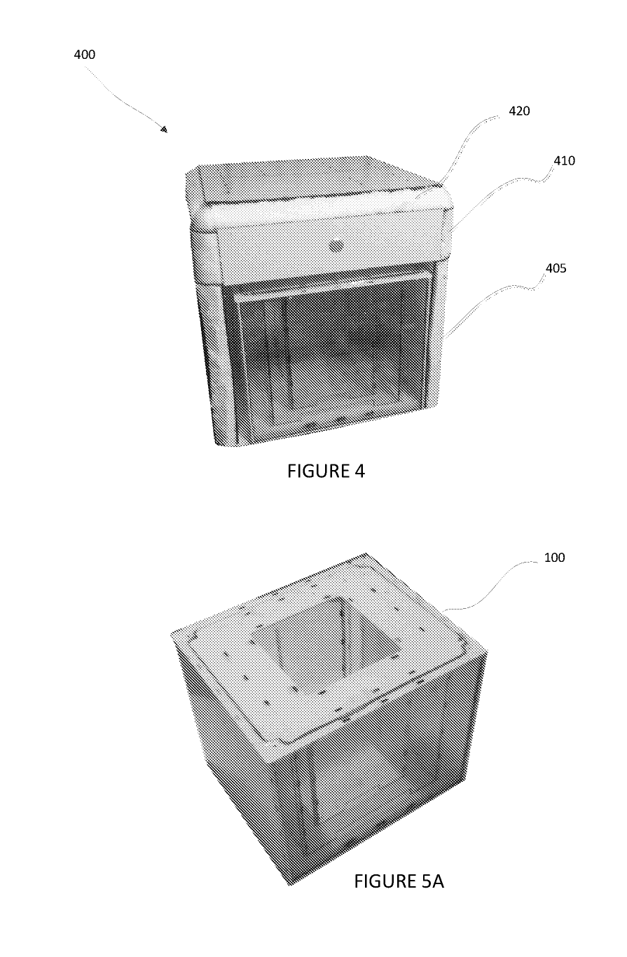

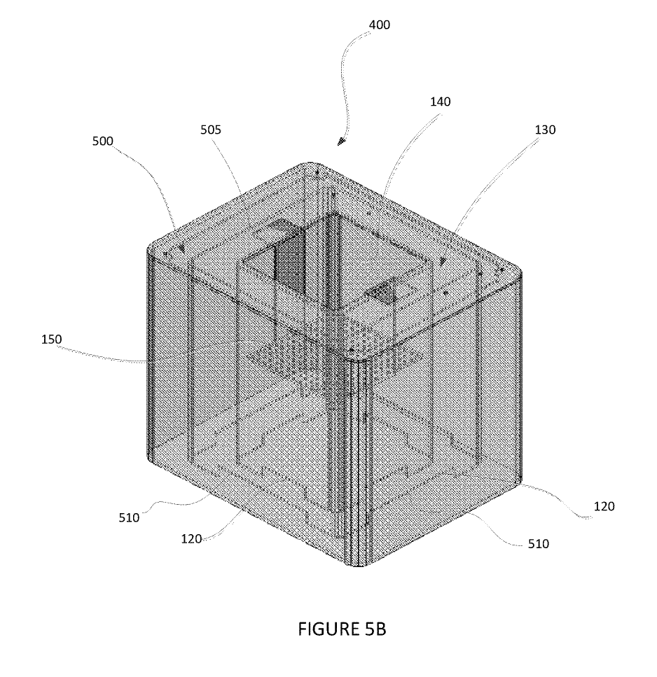

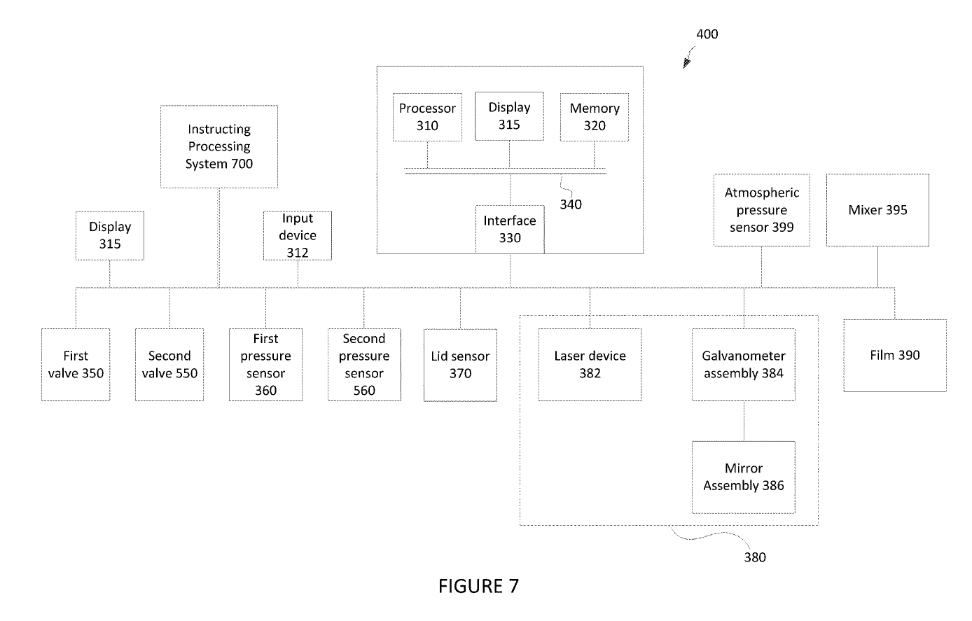

Referring to FIGS. 4 there is shown another example of the three dimensional printer 400 and in FIGS. 5A and 5B there is shown a further example of the tank 100 for use as part of the three-dimensional printer 400 of FIG. 4. FIG. 7 shows a functional block diagram of the controller 300 electrically connected to components of the three-dimensional printer 400 of FIG. 4.

As shown in FIG. 4, the tank 100 is housed within a housing 410 including a flip-top lid 420 which is hingedly attached to a base section 405 to move between an open and closed position to allow access to the tank 100 contained therein. The lid sensor 370 senses the movement of the flip-top lid 420 between the open and closed position, wherein the controller 100 restricts actuation of the light source 380 when the lid sensor 370 indicates that the lid 420 is open. The lid 420 can house the light source 380 but alternatively the light source 380 may be located behind the tank 100 within a cavity 1430 (see FIG. 14C) of the base section 405 of the housing 410. The lid 420 can also include a set of mirrors 1410, 1420 (see FIG. 14C) to direct the light generated by the light source toward the production medium 210 within the first chamber 140.

Referring more specifically to FIGS. 14A, 14B, 14C and 14D, the housing 410 includes two side walls, a rear wall, a lid 410 and a base. In certain embodiments, no front wall is provided such that the housing 410 defines a tank cavity to receive the tank 100. The tank 110 can be slidably received within the tank cavity. As shown in FIGS. 14A, 14B and 14C, the external wall of the tank 110 can include an etched measuring scale to measure the support medium 200 and production medium 210 supplied within the tank 100. As shown in FIG. 14A, the lid 420 can include a lip which overlaps the upper wall of the tank 100 to block any light from exiting the housing 410 during printing operation.

Referring to FIGS. 5A and 5B, the tank 100 includes a first and second chamber 140, 130 as well as a third vessel 500 provided in the form of a third chamber of the tank 100. The second chamber 130 enables the production medium 210 to rise within the first chamber 140, as discussed in relation to the previous example. However the provision of the third chamber 500 enables the production medium 210 to fall within the first chamber 140 under control of the controller 300.

The first, second and third chambers 140, 130, 500 are provided in a nested chamber arrangement. In particular, an area located between a first set of upstanding partitions 505 and the walls of the tank 100 define the third chamber 500. An area located between a second set of upstanding partitions 110 and the first set of upstanding partitions 505 defines the second chamber 130. The area located inwardly of the second set of partitions 110 defines the first chamber 140. Each partition 505, 110 of the first and second set of partitions includes an aperture 510, 120 located adjacent a base portion thereof, such that first, second and third chambers 130, 140, 500 are in fluid communication with each other.

The three-dimensional printer 400 also includes a second pressure adjusting device 550 (see FIG. 7) provided in the form of a second valve which is electronically controllable. Similarly to the previous example, actuation of the first valve induces a flow of support medium 200, such as saline, to the first chamber 140 such that the level of production medium 210 supported upon the support medium 200 in the first chamber 140 rises to enable curing of layers of the production medium 230. In the current example, the same process applies, however the third chamber 500 remains sealed such that no support medium 200 flows into the third chamber 500 whilst support medium 200 flows into the first chamber 140. In the event that the production medium 210 needs to fall within the first chamber 140, the second chamber 130 is sealed and the second valve 550 of the third chamber 500 is electrically actuated to an open state and controlled by the controller 300 to enable some of the support medium 200 to flow into the third chamber 500 whilst the control medium 99 exits the third chamber in a controlled manner via the second valve 550. The level of the support medium 200 in the second chamber 130 is maintained during this process due to the sealing of the second chamber 130, however, the level of the support medium 200 in the first chamber 140 reduces as support medium 200 flows into the third chamber 500. Once the desired lowering of the level of the production medium 210 has been achieved by the controller 300, the controller 300 can actuate the second valve 550 to a closed position such that the third chamber 500 is resealed.

As shown in FIG. 7, the controller 300 in this example is electrically connected to the second valve 550 to enable the control medium 99 within the third chamber 500 to exit such that support medium 200 can flow 291 into the third chamber 500 via apertures 510 in the first set of partitions 505. The controller 300 can also be in electrical connection to a second pressure sensor 560 in the form of a second barometric sensor which senses the pressure within the third chamber 500. The second pressure sensor 560 transfers a feedback signal indicative of the pressure within the third chamber 500 to the controller 300 to allow the controller 300 to control the opening and closing of the second valve 550 such that the production medium 210 within the first chamber 140 falls the required distance. As discussed in relation to the first example, the controller 300 may have stored in memory or may receive from an instructing processing system data indicative of the change in pressure required in the third chamber 500 to achieve a particular fall of the level of the production medium 210 in the first chamber 140.

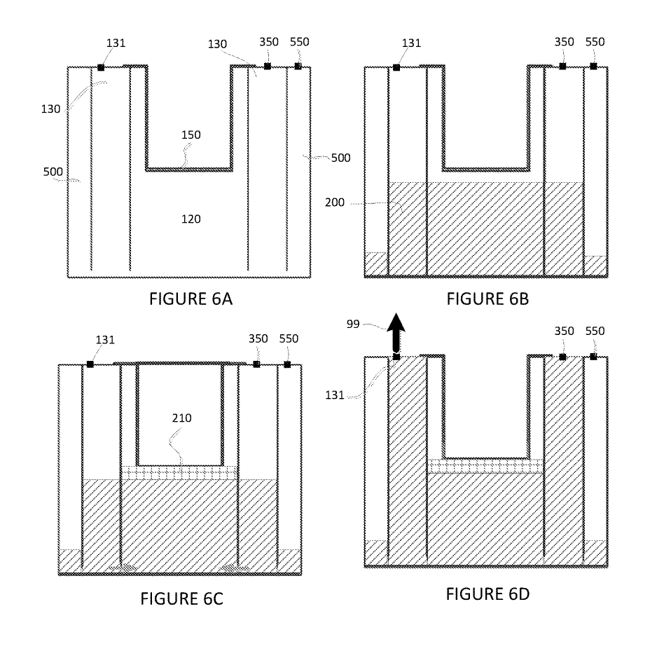

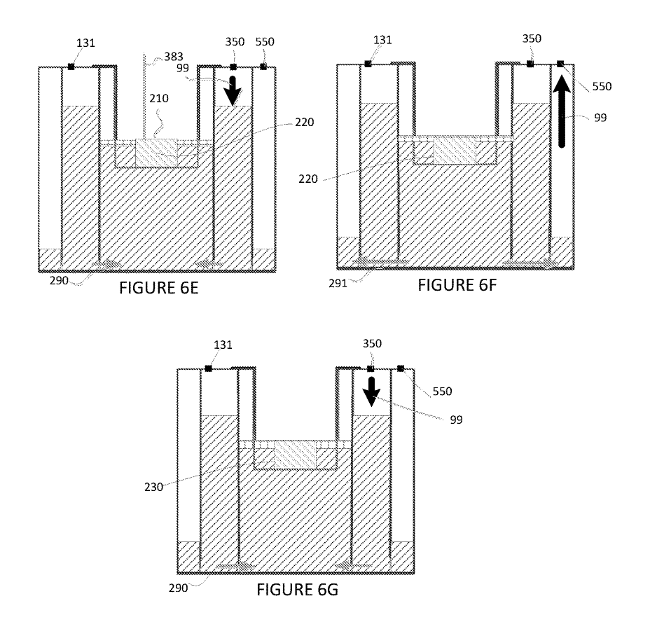

Referring to FIGS. 6A to 6G, there is shown a series of cross-sectional views of the tank 100 during steps for setting up and operating the three dimensional printer 400 as discussed in relation to FIGS. 4.

FIG. 6A shows the tank 100 in the empty state. As shown in FIG. 6B, a supply of support medium 200 is supplied into the first and second chambers 140, 130 such that the level of the support medium 200 contained in the tank 100 at least covers the apertures 510, 120 adjacent the base portion of the first and second set of partitions 505, 110.

A suitable amount of curable production medium 210 for printing is then provided into the first chamber 140 which is supported upon the upper surface of the support medium 200 contained in the first chamber 140 such that the upper surface of the production medium 210 is adjacent to the underside of the build platform 150.

Next, as shown in FIG. 6C, the first chamber 140 is sealed by closing the open top of the second chamber with the lid 220. Furthermore, the third chamber 500 is sealed by closing the second valve 550. Further support medium 200 can then be supplied into the second chamber 130 as shown in FIG. 6D. Due to the first and third chambers 140, 500 being sealed, the level of support medium 200 in the second chamber 130 rises whilst the levels of support medium 200 in the second and third chambers 140, 500 are maintained at the same level prior to adding the further support medium 200. Once an amount of support medium 200 has been supplied to the second chamber 130 or the second chamber 130 is full, the lid 220 can be unsealed and the three-dimensional printer 400 is ready for printing a three-dimensional object 230.

As shown in FIG. 6E, the controller 300 controls the light source 380 to generate a light which is directed toward and cures a first layer of the production medium 230 to the build platform 150. Once curing of the layer 230 has completed, the controller 300 then controls the first valve 350 of the second chamber 130 to allow for a flow 290 of support medium 200 into the first chamber 140, thereby raising the production medium 210 a distance equivalent to a layer thickness of the three-dimensional object 230 to be printed. Once the distance has been achieved, the first valve 350 is closed by the controller 300. The controller 300 then controls the light source 380 to generate the light to cure a second layer of the production medium 210 which cures to the already cured production medium 230 attached to the build platform 150. Once the respective layer 230 has been completed, the controller 300 controls the first valve 350 to cause the production medium 210 to rise again in the first chamber 140 by the thickness of a layer of the three-dimensional object 230 such that the next layer can be generated. This process can continue until the job is completed or the pressure within the second chamber 130 is equivalent to the atmospheric pressure.

In some instances, it may be beneficial that a layer of production medium 210 be cured in multiple phases (i.e. a portion of an initial layer is printed, then after other layers are printed, the printer 400 returns to the initial height to complete printing the remainder of the initial layer). Additionally, in some instances, the production medium when cured 230 expands, wherein it has been found that recoating the recently cured production medium 230 compensates for the expansion and ensures that layers are created consistently. Therefore, as shown in FIG. 6F, the controller 300 can lower the level of the production medium 210 in the first chamber 140, in accordance with received printing instructions, via actuation of the second valve 550 of the third chamber 500. In particular, the controller 300 seals the second chamber 130 and then opens the second valve 550 of the third chamber 500 in a controlled manner to enable the control medium 99 to exit via the second valve 550. This actuation of the second valve 550 results in support medium 200 flowing 291 into the third chamber 500. The level of the support medium 200 in the second chamber 130 is maintained due to the sealing of the second chamber 130. A feedback signal is received by the controller 300 from the second pressure sensor 360, wherein once a desired reduction in pressure has been sensed within the third chamber 500, the controller 300 actuates the closing of the second valve 550. In the instance of the expanding cured production medium 230, the controller 300 may actuate the second valve 550 to raise the production medium 210 by at least two layers in the first chamber 140 to recoat the recently cured layer 230 with supported production medium 210 as shown in FIG. 6F, then close valve 550 and actuate the first valve 350 so as to decrease the height of the production medium 210 within the first chamber 140 by a distance of a single layer as shown in FIG. 6G. The next layer can then be generated as discussed above. This process may be performed every n^{th} layer although this process may also occur when a number of points to be generated in a particular layer exceed a threshold stored in memory 320.

In the event that the level of the support medium 200 contained in the first and second chambers 140, 130 is substantially equal prior to the printing job being completed, the printing job can be paused such that further support medium 200 can be supplied into the second chamber 130 to allow for the printing job to the finished. In specific implementations, the controller 300 may detect that a state of equilibrium is being reached (or soon to be reached) by comparing the detected pressure in the second chamber 130 against the atmospheric pressure as previously discussed, wherein when the pressures are substantially equal, the controller 300 pauses the printing process to allow for further reconfiguration of the three-dimensional printer 400. In particular, the third chamber 500 is sealed whilst the lid 220 of the first chamber 140 is once again resealed. Further support medium 200 is then supplied into the second chamber 130 via the inlet 131. Once a sufficient amount of support medium 200 has been supplied or the second chamber 130 is full, the second chamber 130 is once again sealed and the lid 220 of the first chamber 140 unsealed. The printing process can then be reinitiated by the controller 300 since further potential energy is contained in the second chamber 130 to cause the production medium 210 in the second chamber 220 to rise (or fall) via control of the first valve 350 (or second valve 550).

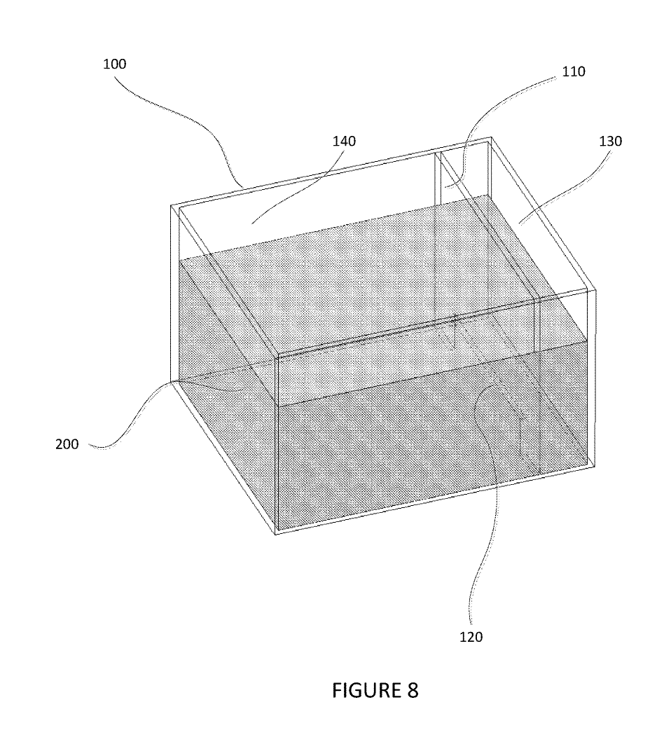

Referring to FIG. 8 there is shown a further example of a tank 100 for a three-dimensional printer 400. In particular, the tank 100 includes a first and second chamber 140, 130 which are defined by a single partition 110 which extends across opposing walls of the tank 100. The single partition 110 includes an aperture 120 adjacent the base section thereof to enable a flow 290 of fluid between the second chamber 130 and the first chamber 140.

As shown in FIGS. 3 and 7, the light source 380 can be provided in the form of a laser assembly 380 which can include a laser device 382 electrically connected to the controller 300 for generating the light in the form of a laser beam 382. The laser assembly 380 further includes a galvanometer assembly 384 electrically connected to the controller 300, and a plurality of mirrors 386 coupled to the galvanometer assembly. The controller 300 controls an orientation of the mirrors 386 via actuation of the galvanometer assembly 384 to control a location which the laser beam 383 is directed toward the supported production medium 210. Thus, the laser assembly 380 actuated by the controller 300 controls the generation of the cured production medium 230 in an x and y axis, whilst the induced flow of the support medium 200 into the first chamber 140 or third chamber 500 results in adjustments of the printing process in the z axis. In a preferable form, the laser device 382 is a 405 nm 500 mW TTL laser. Additionally, in a preferable form, the galvanometer assembly 384 can be provided in the form of a 35 kpps laser galvanometer.

In an additional or alternative embodiment, the light source 380 may be provided as a digital light projector or a series of ultra-violet light emitting diodes (LEDs). In the case of a digital light projector, an image is projected onto the production medium 210 which represents a layer of the three-dimensional object 230, thus curing portions of the production medium 210 simultaneously.

In a particular embodiment, the light source 380 can be configured to generate a first light, such as a first laser beam, and a second light, such as a second laser beam. The first light can have a frequency for curing at least a portion of the production medium 210 contained in the first chamber 140. The second light can have a second frequency which does not cure the production medium 210. For example, the second light may have a wavelength of 808 nm. In tests it has been found that the second light can be directed to strike the cured production medium 230 to control the cured production medium's 230 position within the first chamber 140. The controller 300 can selectively control the light source to generate a first light or a second light depending upon whether a portion of the production medium 210 requires curing or whether the position of the three-dimensional object 230 requires to be maintained within the first chamber 140. It will be appreciated that in this arrangement, the build platform 150 is not considered required as the position of the three-dimensional object 230 being generated in the first chamber 140 can be controlled via the second light.

In certain embodiments, the three dimensional printer 400 includes a mixer 395 controllable by the controller 300 to mix components of the support medium 200. In particular, it has been found that in particularly long printing jobs, the support medium 200, such as saline solution, may separate. Thus, the provision of a low speed mixer 395 assists in avoiding the support medium 200 separating during long print jobs. The mixer 395 can be located in the second chamber 130 in order to avoid the propagation of disturbances to the top surface of the production medium 210 within the first chamber 140 of the tank 100. In another embodiment, the three-dimensional printer 400 may include a mixing module which is separate to the chambers. The mixing module may include a container containing a first component for the support medium 200, such as salt, and an inlet for receiving a second component of the support medium 200, such as water. The mixing module may include the mixer 395 for mixing the components together. The mixing module may also include an outlet which provides the mixed support medium 200 to the various chambers. In one form, the mixing module may be in fluid communication with a water source, such as a tap, via an electrically controllable valve which can be controlled by the controller 300, such as to avoid the user having to refill the container.

In one variation, the first pressure altering device 350 can be provided in the form of a drip feed assembly to drip support medium 200 into the second chamber 130 causing the pressurization of the second vessel 130 due to the increase in weight of the support medium contained in the second vessel 130 which causes at least some of the support medium 200 to be displaced and flow into the first chamber 140, resulting in the production medium 210 rising. The drip feed assembly can include a valve which can be electrically controlled by the controller 300 to cause the flow of support medium 200. A drip detector device, which is in electrical communication with the controller 300, can be configured to detect the number of drips that enter the second chamber 130. The drip detector can be provided in the form of two electrical contacts which the drips pass therethrough. When a drip passes through the contacts, an electrical connection is formed between the pair of electrical contacts which is used as an indication of a detected drip. The drip detector device can provide a feedback signal indicative of each drip detected to the controller 300 which can be used to determine the height of the production medium 210 in the first chamber 140. The controller 300 can have stored in memory 320 data indicative of the number of drips required to be detected to raise the production medium 210 by a required layer thickness, wherein the controller 300 uses the number of drips detected and this data stored in memory 320 to control the valve of the drip feed assembly accordingly for the print job. As will be discussed later in this disclosure, the drip feed assembly may alternatively drip production medium 210 into the second chamber in embodiments where only production medium is used rather than the support medium.

In another variation, the first pressure altering device 350 is a source of inert gas, wherein the controller 300 controls a supply of the inert gas to the second chamber 130 causing the production medium 210 to rise within the first chamber 140. In one form, the supply of inert gas may be a pressurised air supply, wherein pressurised air is supplied into the second chamber 130 to cause a flow of support medium 200 from the second chamber into the first chamber 140. The pressurized air supply can be provided in the form of a pressurised canister containing pressurised gas. In previous examples, when the level of the support medium 200 in the second chamber 130 is equal to the first chamber 140, the insert gas may be supplied to the second chamber 130 to complete the printing job. In this manner, a hybrid system is used for adjusting the level of the production medium 210 in the first chamber 140.

In a further variation, the first pressure altering device 350 is a fluid fillable device such as a bladder which is located within the second vessel 130. The fluid fillable device can be in filled with fluid such as a gas or liquid provided by a fluid source. The fluid fillable device can be in communication with a valve which is operably controllable by the controller 300 to control the flow of fluid to and from the fluid fillable device. As the fluid fillable device fills with fluid from the fluid source under control by the controller 300, the second vessel 140 pressurises such that at least some of the support medium 200 contained within the second vessel 130 is displaced and flows into the first vessel 140 via the passage, thereby raising the production medium 210 within the first vessel 140. Similarly, if fluid is able to be dispensed from the fluid fillable device, the size of the fluid fillable device reduces causing depressurization of the second vessel 130 thereby allowing for at least some of the support medium 200 to flow from the first vessel 140 back to the second vessel 130 via the passage, thereby lowering the production medium supported within the first vessel 130.

In a further variation, the second chamber 130 may be coupled via one or more of the ports to a vacuum source to cause a change in pressure within the second chamber 130. In particular, the vacuum source may cause a decrease in pressure within the second chamber 130 resulting in a flow of support medium 200 from the first chamber 140 into the second chamber 130, thus resulting in the upper surface of the production medium 210 falling within the first chamber 140. This configuration can therefore avoid the use of a third chamber 500 if required.

The controller 300 can be configured to receive G-code instructions for printing the three-dimensional object 230, however it will be appreciated that other forms of instructions can also be provided by an instructing processing system.

In one form, the tank 100 or the housing 410 may be at least partially covered with a smart film 390, also known as switchable film. The smart film 390 can include Polymer Dispersed Liquid Crystals (PDLCs) which adjusts light transmission between transparent and opaque using AC power such that the photo-sensitive production medium 210 contained in the first chamber 140 is protected from external light. In particular, the film 390 may be operably connected to the controller 300, wherein when no electrical power is provided to the smart film 390, the liquid crystal molecules (microdroplets) are disordered such that the film restricts light entering the tank 100. When electrical power is provided to the smart film 390, the liquid crystal molecules are forced into alignment, rendering it transparent such that the user can view into the tank 100. The controller 300 can be selectively operated by the user between these states.

In particular embodiments, the controller 300 can include a wireless communication interface to enable the controller 300 to communicate with the instructing processing system via a wireless communication medium such as WiFi, Bluetooth, or the like.

As previously discussed, the support medium 200 can be provided as saline, however other types of support medium 200 can also be used which has a greater density than the production medium 210. Generally, the support medium 200 is a flowable substance. For example, sucrose solutions, clean water, wood ethanol, petrochemical, or graphite powder could also be used as a support medium 200. In an alternate arrangement, no support medium is provided such that only a supply of the production medium 210 is provided into the tank 100. In this arrangement, there is no need to supply an amount of support medium 210 in the tank as the level of the production medium 210 in the first chamber 140 is adjusted by controlling the pressure altering device 350 in order to apply a force directly to a portion of the production medium 210 contained in the second chamber 130, causing a flow of production medium 210 from the second chamber 130 into the first chamber 140 via the passage such as to increase the upper level of the production medium 210 in the second chamber 140.

In another variation, the chamber partitions 110, 505 can be removable from the tank 100 and are reconfigurable. In particular, the partitions 110, 505 can be attached to the base of the tank 100 in various locations to adjust the size of the various chambers 130, 140, 500. Additionally, the number of partitions can be adjusted such that a two or three chamber tank 100 can be defined by the user depending upon the specific print job.

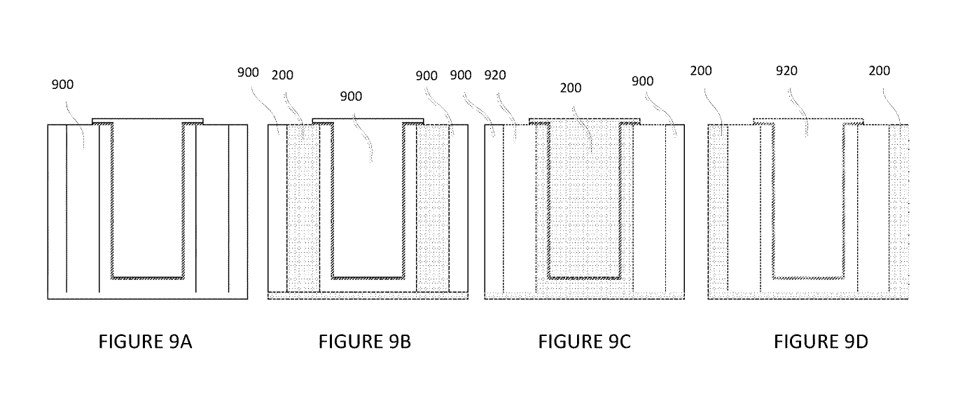

In one embodiment, it may be beneficial to flush the tank 100 of air. This can be achieved by reducing the pressure within the tank 100 by application of a vacuum and replacing the air using another inert gas via one or more of the ports. Referring to FIGS. 9A to 9D there is shown a process of flushing air from the tank 100 such that an alternate control medium 99 is contained therein. In particular, FIG. 9A shows the tank 100 in the empty state wherein air 900 is contained in the chambers 130, 140, 500. Support medium 200 can then be supplied to the second chamber 130, as shown in FIG. 9B and as discussed in previous examples, wherein the first and third chambers 140, 500 are sealed. At FIG. 9C, a port on the lid 220 of first chamber 140 is opened and a pressurised supply of inert gas 920 which is not air is supplied via one or more of the ports 131 of the second chamber 130. The pressurised gas may be pumped into the tank via a pump or alternatively provided from a pressurised gas source. This causes the air 900 contained in the headspace of the first chamber to flow out of the first chamber 140 and the inert gas 920 to be contained within the second chamber 130 as shown in FIG. 9C. The port of the lid 220 is then closed and the second valve 550 of the third chamber 500 is opened causing the remaining air 900 in the third chamber to be flushed from the third chamber 500 via the flow of the support medium 200 into the third chamber. In one example, the inert gas 920 may be argon which can cause excitation with the light generated by the light source 380 during curing of the production medium 210. In this embodiment, the lid 220 may remain sealed with the first chamber 140 although a port in the lid may be controlled to allow the flow of the inert gas out of the first chamber 140. In this arrangement, the light generated by the light source 380 passes through the lid which is transparent. The controller 300 may adjust the laser source 380 to take into account refraction which the light undertakes as it passes through the lid 220.

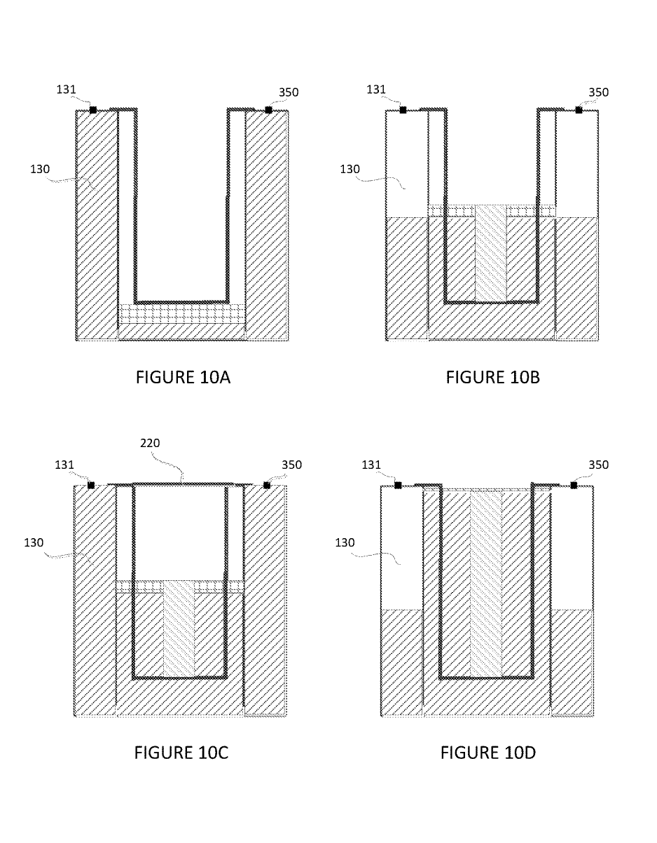

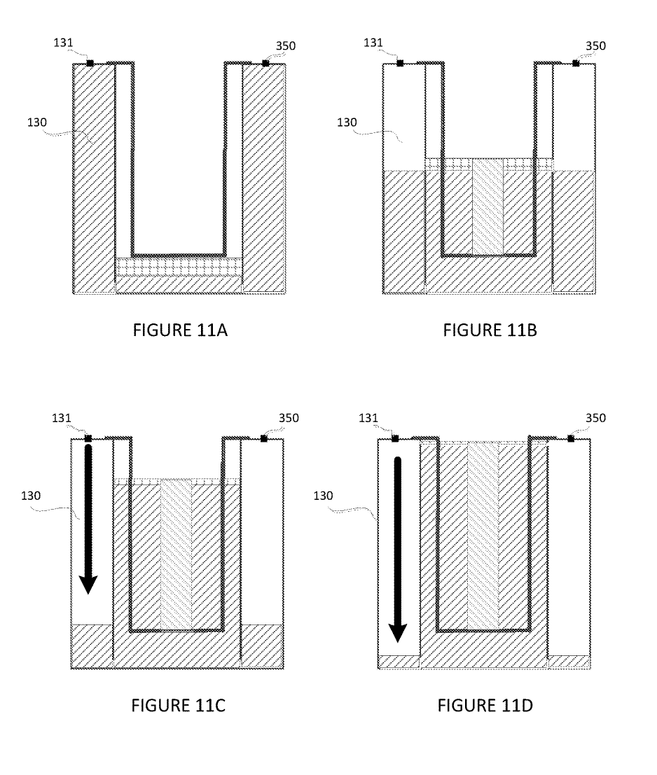

Referring to FIGS. 10A to 10D, there is shown a series of steps for producing a three dimensional object 230 which is substantially the height of the first chamber 140. In particular, as shown in FIG. 10A, the tank 100 is primed for production. FIG. 10B shows the situation where the levels of the support medium 200 are equal in the first and second chamber 140, 130. In FIG. 10C, the first chamber 140 can be sealed with the lid 220 and the second chamber 130 can be refilled with support medium 200. In FIG. 10D, the printing process can recommence such that a three-dimensional object 230 which is substantially the length of the first chamber 140 is produced. Referring to FIGS. 11A to 11D, an alternative method is shown to that of FIGS. 10A to 10D. In particular, FIGS. 11A and 11B correspond to FIGS. 10A to 10B. In FIG. 11C, a supply of pressurised control medium 99 is supplied to the second chamber 130 via one or more of the ports 131 such that the level of the production medium 210 increases whilst further layers are printed. FIG. 11D shows the state of the chambers when the three-dimensional object 230 which is substantially the length of the first chamber 140 is finalised.

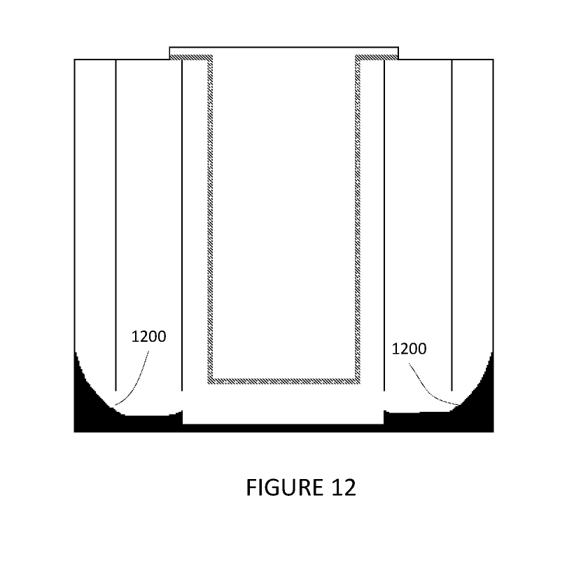

Referring to FIG. 12 there is shown a further embodiment of the tank 100. In particular, the tank includes curved corners 1200 where the base portion of the tank meets the walls of the tank. In situations where the printing job takes a substantial time, the production medium 210 may sink to the base on the tank 100 which can lead to the production medium 210 moving between chambers, 130, 140, 500. The curved corners 1200 within the tank 100 alleviate this risk by promoting the movement of the production medium 210 toward the centre of the chamber 140.

In one variation, the three-dimensional printer 400 can include a temperature sensor to sense the temperature within one or more of the chambers of the tank 100. A temperature feedback signal can be communicated to the controller 300, wherein the controller 300 can control a heating element to maintain at least portions of the tank or the contents therein at a desired temperature. This temperature may be maintained to promote the flow of support medium 200 between chambers or maintain the production medium 210 at a desired temperature.

In another variation, the processor 310 may control the direction of the light generated by the light source based on a scaling factor and the height of the generated three-dimensional object 230. The scaling factor may be stored in memory 320, wherein printing instructions are adjusted by the scaling factor. In particular, the processor magnifies the image which is to be generated for each layer as the height of the three dimensional object increases. For example, consider a situation where the three dimensional printer 400 can produce 1,000,000 1 micron layers, where the object has 5000 layers and each layer is 10 microns thick. Each layer is magnified according to the following calculations by the processor:

Layer 1: Image scaled by (calibration X & calibration Y) by (scaling factor x 1)

Layer 2: Image scaled by (calibration X & calibration Y) by (scaling factor x (1+10/1,000,000))

Layer 3: Image scaled by (calibration X & calibration Y) by (scaling factor x (1+20/1,000,000))

Layer 5000: Image scaled by (calibration X & calibration Y) by (scaling factor x (1+50,000/1,000,000))

In another embodiment, the controller 300 receives audio data, wherein the controller 300 controls the laser assembly 380 according to the audio data. For example, the audio data may be music, wherein the laser assembly 380 is controlled according to the beat of the music or other notable sections or characteristics of the music. In this situation, the speed which the laser assembly 380 is actuated by the controller 300 is slowed in accordance with the audio data. This embodiment provides a light show to the user for entertainment purposes. In another form, the audio data may be used by the controller 300 to manipulate the direction which the laser strikes the production medium 210. For example, printing instructions indicative of a cylinder could be provided from the instructing processing system 700, however the cylinder is altered according to the received audio input data such that a unique three dimensional object is produced based on the audio data. In some forms, the audio data may be live music which is captured via a microphone and provided to the controller 300.

In another embodiment, the tank 100 and/or the housing 400 may include an exhaust fan and a filter such that fumes such as noxious gas or vapour produced during the curing process is not exposed to the user. As shown in FIG. 14D, the filtered exhaust may exit the housing via housing portion 1440. The lid 410 can include a rubber air tight seal.

In another embodiment, the housing 410 and/or the tank 100 can include adjustable feet to assist with levelling of the tank 100. The housing and/or tank can include a spirit level or accelerometer to sense whether the housing and/or tank is level. In the case of the accelerometer, the controller 300 can be in operably connected thereto to receive a sensor signal which can be presented via the display 315 to the operator.

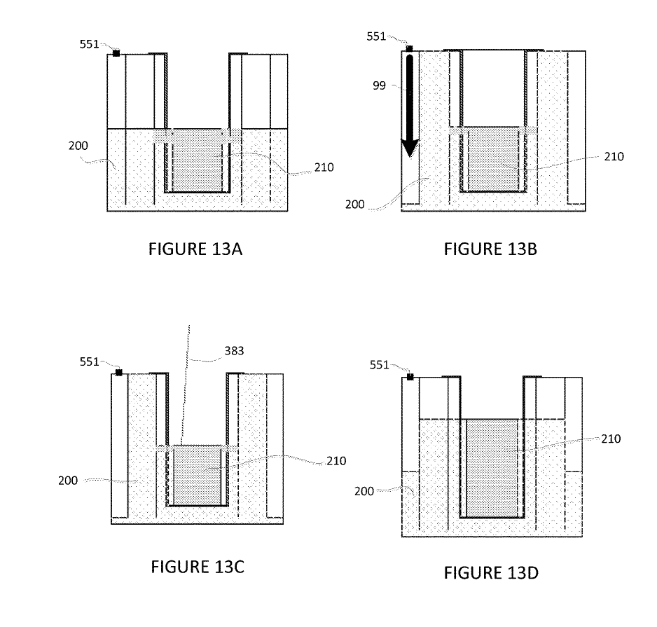

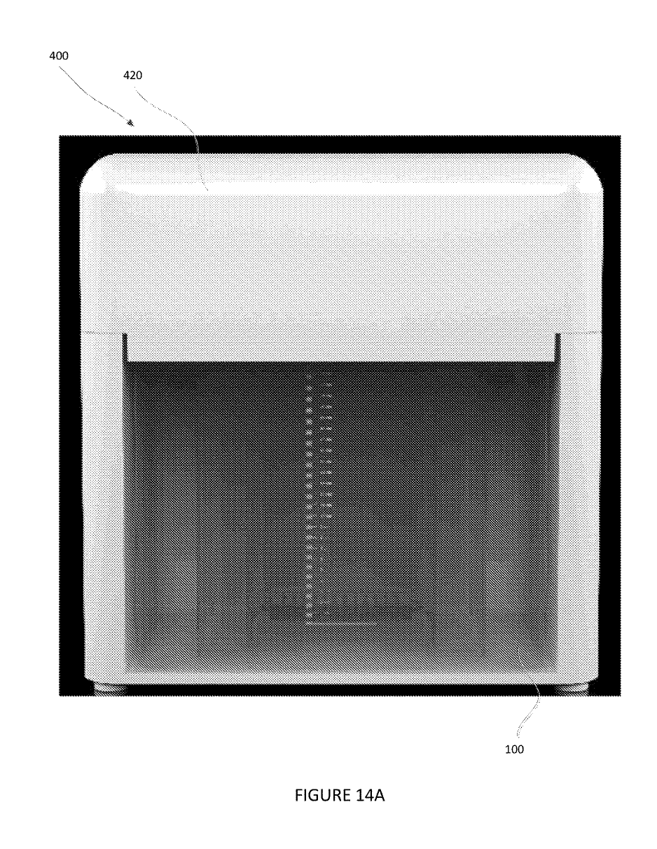

Referring to FIGS. 13A to 13D there is shown a series of cross-sectional views of the tank of FIG. 4. In particular, in FIG. 13A the tank is shown where the level of the support medium 200 in each chamber is equal such that the tank has reached a state of equilibrium. In FIG. 13B, the first chamber 140 is sealed, a port 551 of the second chamber 130 is opened, and a pressurised source of control medium 99, such as pressurised gas, is fed into the third chamber 500 via the one or more ports. This causes the support medium 200 contained in the third chamber to rise in the second chamber 130 as shown in FIG. 13C. Once a sufficient amount of support medium 200 has been contained in the second chamber, the ports of the second and third chambers 130, 500 are closed and the lid 220 unsealed from the first chamber 140. The printing process can therefore recommence where the valve 350 is controlled to cause a flow of support medium 200 from the second chamber 130 to the first chamber 140 thereby causing the production medium 210 to rise within the first chamber 140. It will also be appreciated that the third chamber 500 can similarly be used as previously discussed to lower the production medium 210 in the first chamber 140 by the controller 300 actuating the valve 550 in a controlled manner.

In instances where the consecutive layers to be cured for the three dimensional object are identical, the valve of the second chamber may be actuated by the controller 300 to maintain a flow of support medium 200 into the first chamber 140 for the consecutive layers. For example, in embodiments where the light source is the digital light projector, the controller 300 controls the digital light projector to project the image of the repeated layer onto the production medium 210 for a period of time which corresponds to the number of layers which the same layer is to be generated. Each layer takes the same amount of time to cure regardless of the complexity of the layer. As each layer is being cured, the production medium 210 is simultaneously rising within the first chamber 140. Once the exposure period has been reached for the respective layer, the controller can control the digital light projector to project the next image for the next layer to be cured. This process therefore avoids the opening and closing of the valve between layers when the same layer structure is being generated between consecutive layers. It will be appreciated that a similar process can also be applied for a laser assembly system. The controller can be configured to analyse the printing instructions to identify consecutive layers which have the same structure such that the valve can be maintained in an open state.

In another embodiment, the third chamber 500 may be used as an additional second chamber, wherein the flow of support medium 200 from the third chamber 500 causes the production medium 210 to rise in the first chamber.

In another embodiment, the light source 380 can include a light emitting head mounted on a displacement assembly to allow the head to move in a single dimension or potentially a two dimensional plane. More specifically, the light emitting head includes a gantry system using one or more stepper motors cooperating with one or more pulleys and/or cogs. When the one or more stepper motors are actuated, the one or more pulleys and/or cogs which are in mechanical cooperation cause the light emitting head to move in the single dimension or the two dimensions accordingly. Thus, the stepper motor can be actuated to trace the emitted light over the production medium 210 such that the light is directed in a substantially orthogonal direction to movement of the light emitting head.

It is possible that the light emitting device of the light emitting head can remain activated substantially constantly during the movement by the displacement assembly. Additionally, substantially no compensation is required for beam shape or angle of attack. Additionally, as the one or more cogs or pulleys can be made from plastic, the cost of the printer 400 is kept to a minimum.

In the instance that a moveable light emitting assembly is provided which moves in a single dimension, it is possible that the light emitting head can include a plurality of controllable light emitting elements, such as a strip of UV light emitting diodes, or a scanning laser system. In this instance, the controller controls the UV light emitting diodes or the scanning laser system such that the light emitted toward the production medium 210 can be electronically controlled by the controller thereby causing light to be selectively emitted in a first dimension (e.g. Y axis) in combination with the mechanical movement of the light emitting head occurring in an orthogonal second direction (e.g. X axis) such that a two dimensional pattern can be projected onto the production medium 210 over time.

In certain embodiments, the three-dimensional printer 400 may include one or more additional chambers 1540, 1610 for providing a supply of pressurised control medium 99 to the second chamber 130 or for extracting an amount of control medium 99 from the first chamber 140 in situations where equilibrium has been reached.

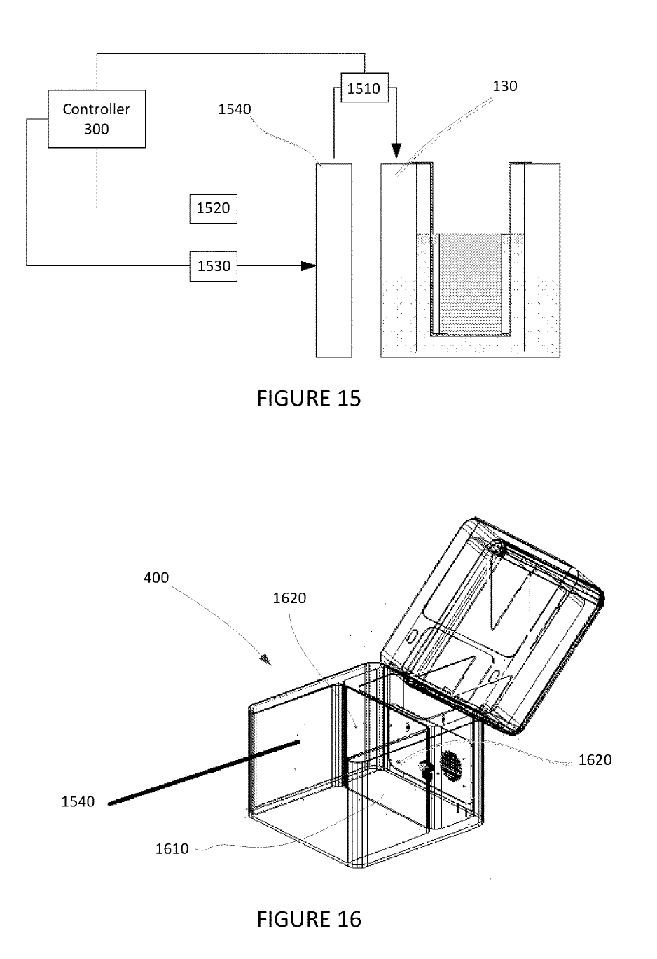

In particular, referring to FIG. 15 there is shown a schematic of a control system for supplying a controlled amount of pressurised control medium 99 to the second chamber 130. In particular, the controller 300 is in electrical communication with a barometer 1520, a pump 1530 and a solenoid valve 1510. The barometer 1520 senses the pressure within the additional chamber 1540 which contains the pressurised supply of control medium 99 which can be pressurised air. The pump 1530 is in fluid communication with the additional chamber 1540 such that when the pump 1530 is electrically actuated by the controller 300 in response to a feedback signal from the barometer 1520 indicating that the pressure within the additional chamber 1540 is under a threshold, the pump 1530 fills the additional chamber 1540 with control medium 99 until the threshold pressure is reached. The solenoid valve 510 includes a first port in fluid communication with the additional chamber 1540 and a second port which is in fluid communication with the second chamber 130. When the three dimensional printer 400 has reached a state of equilibrium, the controller 300 can actuate, either selectively by the user or automatically in response to sensing the equilibrium state, the solenoid valve 1510 to allow the pressurised control medium 99 to flow from the additional chamber 1540 to the second chamber 130. The flow of the control medium 99 into the second chamber 130 causes the level of support medium 200 within the second chamber 130 to fall and the level of the production medium 210 in the first chamber 140 to rise. Thus, the controller 300 can control the amount of control medium 99 entering the second chamber 130 from the additional chamber 1540 to complete the printing job should a state of equilibrium be reached. The pump 1530 can in turn be actuated to return the additional chamber 1540 to the required pressure.

In particular embodiments, a further additional chamber 1610 can be provided which is in fluid communication with a vacuum pump to cause an amount of control medium 99 to be extracted from the first chamber 140, thereby causing the production medium 210 to rise in the first chamber 140. It will be appreciated that the control arrangement for the further additional chamber 1610 can be configured substantially to that described above for the additional chamber 1540 but utilising a vacuum. Referring to FIG. 16 there is shown a schematic of the chassis of the three dimensional printer 400 including the first and second additional chamber 1540, 1610, wherein the first additional chamber 1540 supplies the pressurised control medium 99 to the second chamber 130 and the second additional chamber 1610 extracts the control medium 99 from the first chamber 140. The solenoid valves of the chambers 1540, 1610 can be actuated simultaneously or at different times by the controller 300 in order to allow the three dimensional printer 400 to complete the printing job should a state of equilibrium have been previously reached. FIG. 16 additionally shows input/output means 1620 of the chambers 1540, 1610.

In a further embodiment, the at least one of the chambers, preferably the outermost chamber of the chassis of the three-dimensional printer 400, can include a valve, such as a tap, to allow the user to selectively empty the one or more chambers.

In particular embodiments, an the controller may be configured to electrically control the intensity of the light emitted by the light source. This is advantageous when working with different types of production mediums 210 which may cure at different rates, or cure with different colouring or other physical properties dependent upon the intensity of the light. Additionally, the adjustable control of the light intensity provides an approximation of an extrusion rate which can be defined in numerical control programming languages such as G-code and the like.

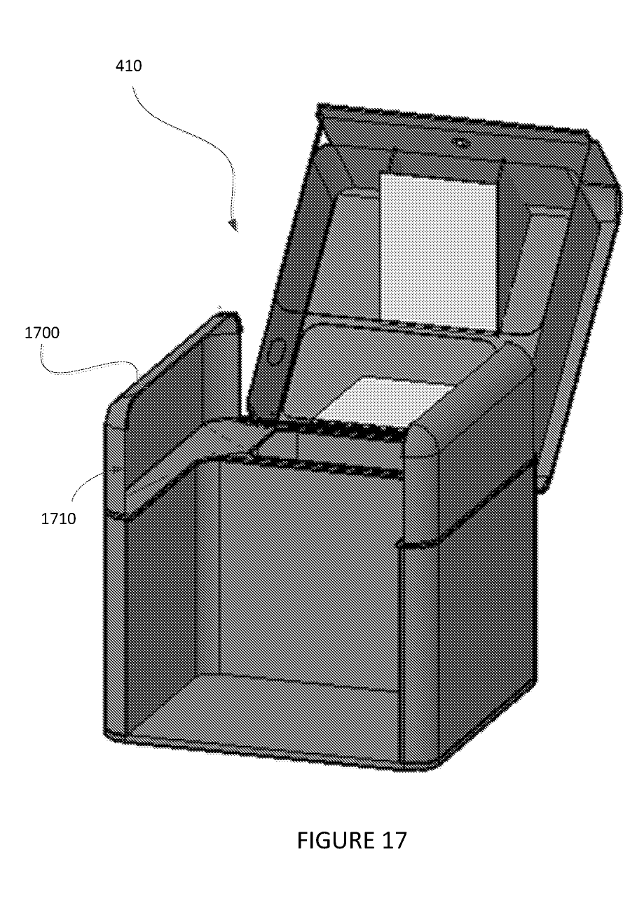

Referring to FIG. 17 there is shown an example of a housing 410 for a three dimensional printer 400. In particular, side walls 1700 of the housing 410 extend upwardly past the top of the vessels such that upper portions of the side walls 1700 meet substantially flush with the top of the lid 420 when in the closed position. The upper portions of the side walls 1700 which are located above the vessels can include a cavity 1710 to allow for various component of the three dimensional printer 400 to be housed. For example, valves can be mounted within the cavities 1710 provided by the upper portions 1700 of the side walls. This configuration is advantageous as the components mounted in the upper side wall cavities 1710 can be easily accessed by the user when the lid 420 has been moved to the open position as shown in FIG. 17. This configuration also reduces the weight of the lid 420 since some of the components which are located in the lid 420 in prior embodiments are located in the upper side wall cavities 1710 of the housing 410.

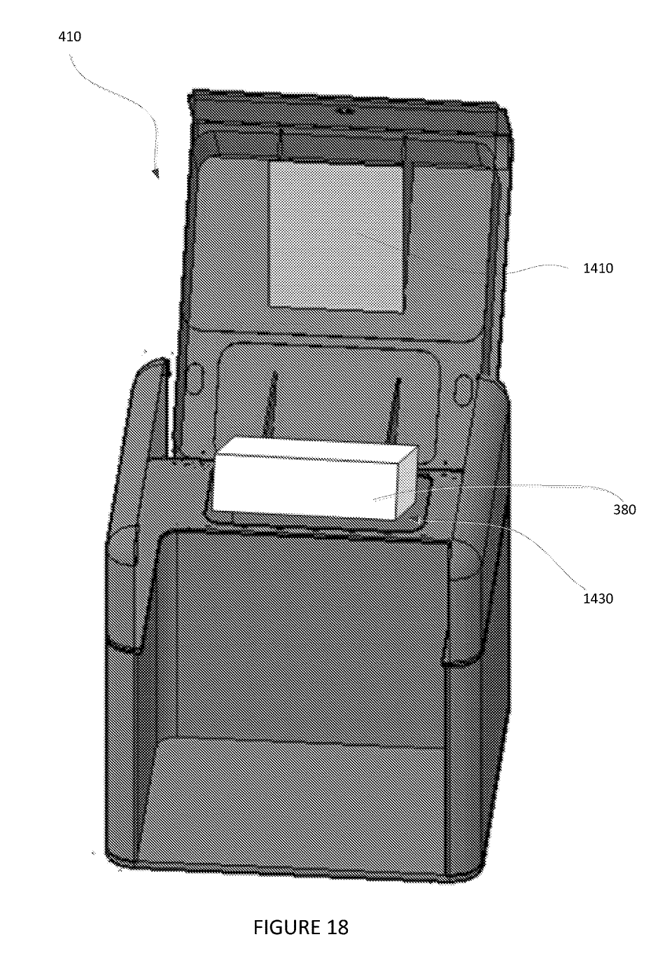

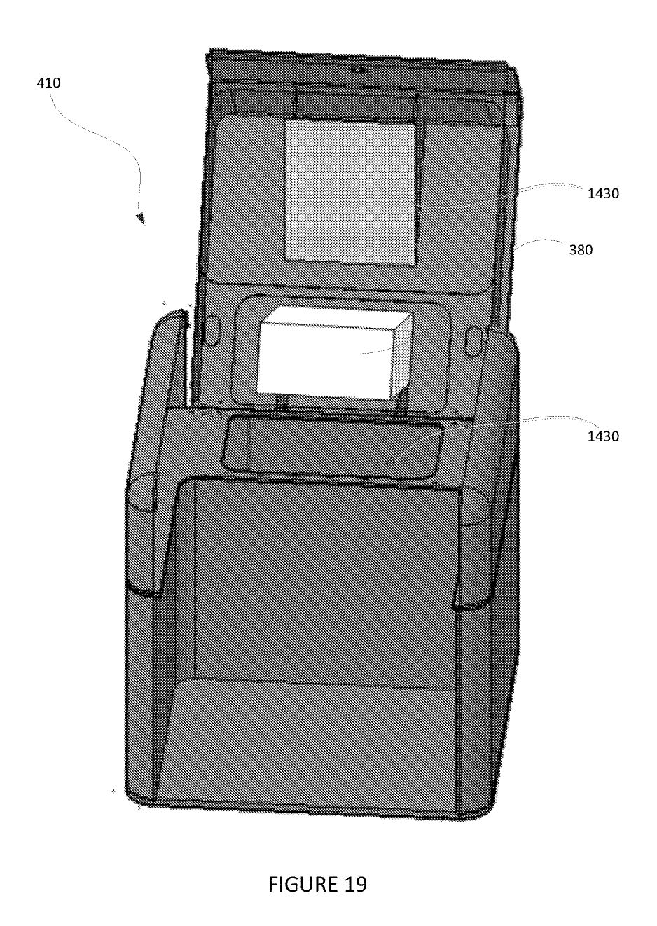

Referring to FIGS. 18 and 19 there is shown another example of a housing 410 for a three dimensional printer 400. In particular, the printer 400 includes only a single light reflecting surface 1410 such as a mirror which is mounted to the inner surface of the lid 420. This configuration allows for the light source 380, such as the projector, to be mounted to either the base section of the housing 410 as shown in FIG. 18 or the lid 420 as shown in FIG. 19, wherein the light emitted by the light source 380 is directed toward the single mirror mounted to the inner surface of the lid 420. This configuration shown in FIGS. 18 and 19 contrasts with certain previous embodiments outlined above where the light source 380 was located at the rear of the housing. As multiple reflections of emitted light can introduce inaccuracies with the final object printed, a single reflecting surface 1410 increases the accuracy of the final printed object. The rear cavity 1430 where the light source 380 was located in previous embodiments can be utilised for housing alternate components of the three-dimensional printer 400. In particular, in certain embodiments, the rear cavity can be utilised for housing a vacuum device and/or pumping system.

It will be appreciated that the controller 300 may control the display 315 to present operating instructions for viewing by the operator. In addition, the controller may include or be in operably connected to an input device 312 which the operator can interact therewith to instruct the controller 300 to undertake operational tasks. For example, the input device 312 may be a keypad or the like. In one form, the display 315 and input device 312 may be provided in the form of an integrated device such as a touch screen interface. The controller 300 may present steps via the display device 315 to be performed by the operator such as refilling a particular chamber, wherein once the operator has refilled the chamber, the operator can interact with the input device 312 to indicate that the step has been performed. However, it will be appreciated that sensors may be provided which are operably connected to the controller 300 to sense when the operator has performed a particular step, thus avoiding the operator having to interact with the input device 312 to confirm that the step has been performed.

As previously discussed, it is possible for the three dimensional printer to operate using the production medium 210 only such that no support medium 200 is used. In particular, the production medium would be contained in both the first and second vessels 140, 130, wherein the controller is configured to control the pressure altering device to pressurise the second vessel 130 to induce a flow of production medium between the second and first vessels 130, 140 via the passage such as to raise or lower the level of the production medium with the first vessel 130 to enable the generation of layers of the cured production medium 230.

In this embodiment and similar to previous embodiments, the control medium 99 could still be utilised where an electronically controllable valve is actuated to control a control medium entering or exiting the second vessel 140. The control medium 99 can be air although other mediums can be utilised.

Similarly to other embodiments, the vessels 130, 140 can be provided as part of a tank 100, wherein the first vessel 140 is a first chamber of the tank 100 and the second vessel 130 is a second chamber of the tank. The first and second chambers are defined within the tank via a partition 110, wherein the partition 110 includes an aperture 120 to allow for at least some of the production medium to be displaced due to the pressurization of the first or second vessels 140, 130 causing the flow of production medium 210 between the first and second vessels. The tank 100 may include a plurality of partitions 110 having a plurality of apertures 120, wherein the plurality of apertures 120 enable a multidirectional flow of production medium 210 between the first and second chambers 140, 130. Each aperture 120 can be located near a base portion of the respective partition to minimise disturbance of the upper level of the production medium 210 which the light emitted by the light source 380 strikes.

Similarly to previous embodiments, the three dimensional printer 400 can include the third vessel 500 in fluid communication with the second vessel 130, and the additional pressure altering device 550 controllable by the controller 300 to induce a flow of control medium 99 into the third vessel 500 such that the production medium 210 flows through the aperture 120 such that the level of the production medium 210 is lowered within the first vessel 210. A base portion of at least one wall of the second vessel 130 includes at least one aperture 510 to allow the flow of the control medium into the third vessel 500 from the second vessel 130. In this embodiment, the controller 300 is configured to control the light source 380 to cure a layer of the production medium 210, wherein the first layer protrudes above the uncured production medium. The controller 300 is also configured to control the pressure altering device 350 to coat the cured layer of the production medium with the uncured production medium. The controller is then configured to control the additional pressure altering device 550 to lower the supported cured production medium 230 for curing the next layer.

As previously discussed, the pressure altering device 350 can be provided in the form of a drip feed assembly for dripping production medium from a production medium source into the second vessel 130 causing the second vessel 130 to pressurise and induce a flow of production medium through the passage 120 thereby raising the level of the production medium 210 in the first vessel 140.

In other arrangements, the first pressure altering device 350 can include a source of inert gas, wherein the controller 300 is configured to control the pressure altering device 350 to supply at least some of the inert gas to the second vessel 130 causing the production medium 210 to rise within the first vessel 130.

In some embodiments as previously discussed, the three dimensional printer 400 can include one or more vacuum devices. At least some of the one or more vacuum devices can be in fluid communication with the second vessel 130, wherein the controller 300 is configured to control the at least some of the one or more vacuum devices causing the production medium 210 to rise within the second vessel 130. At least some of the one or more vacuum devices can also be in fluid communication with an additional vessel which in turn is in fluid communication with the first vessel 140 via a valve operably connected to the controller 300. The controller 300 can be configured to actuate the valve and the at least some of the vacuum devices to induce the flow of the production medium 210, wherein an amount of the control medium 99 is extracted from the first vessel 140 and contained within the additional vessel.

In these embodiments, the three dimensional printer 400 can include a further vessel having a pressurised supply of control medium 99 contained therein and in fluid communication with the second vessel 130 via a valve operably connected to the controller 300. The controller 300 can be configured to actuate the valve to induce the flow of the production medium 210.

It will be appreciated that various valves are utilised in the above-described embodiments of the three dimensional printer 400. The valves can be provided in the form of an electromechanically operated valve such as a solendoid valve which can be electrically actuated by the controller to control the valve state.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A three-dimensional printer including:
a first vessel in fluid communication with a second vessel;
a pressure altering device;
a light source; and
a controller configured to:
control the light source to generate light directed toward a production medium supported by a support medium located within the first vessel to cure a portion of the production medium; and
control the pressure altering device to induce a flow of support medium between the first and second vessels such as to raise or lower the support medium within the first vessel to enable generation of layers of the cured production medium.

2. The three-dimensional printer according to claim 1, wherein the pressure altering component is an electronically controllable valve to control a control medium entering or exiting the second vessel.

3. The three-dimensional printer according to claim 2, wherein at least one of:
the control medium is air; and
the support medium is saline.

4. The three-dimensional printer according to claim 2 including a first pressure sensor for sensing the pressure within the second vessel, wherein the controller is configured to control the pressure altering device based on feedback received from the first pressure sensor.

5. The three-dimensional printer according to claim 1 including a sealable lid which is movable between an open position and a closed position to seal an open top of the first vessel.

6. The three-dimensional printer according to claim 1 including:
a housing including a lid, wherein the housing is configured to house the light source and the first vessel; and
a lid sensor to detect whether the lid is placed in the open or closed position, wherein the controller controls the light source based upon the lid being detected in the closed position.

7-9. (canceled)

10. The three dimensional printer according to claim 1, wherein the light source includes a laser assembly including:
a laser device operably connected to the controller for generating the light in the form of a laser;
a galvanometer assembly operably connected to the controller; and
a plurality of mirrors coupled to the galvanometer assembly, wherein an orientation of the mirrors are controllable by the controller via actuation of the galvanometer assembly to control a location which the laser is directed toward the production medium.

11. The three dimensional printer according to claim 10, wherein the controller is configured to control the galvanometer assembly based on a height of the cured production medium within the first vessel.

12-13. (canceled)

14. The three dimensional printer according to claim 1, wherein the light source is:
a digital light projector; or
a light emitting diode system.

15-16. (canceled)

17. The three dimensional printer according to claim 1, wherein the controller is configured to control the light source to generate:
a first light having a frequency for curing at least a portion of the production medium; and
a second light having a second frequency which does not cure the production medium, wherein the second light is directed toward the cured production medium to control a position of the cured production medium within the first vessel.

18. The three dimensional printer according to claim 1 including a film which is operably connected to the controller, wherein actuation of the film by the controller inhibits external light entering the first vessel.

19. The three-dimensional printer according to claim 1 including a tank, wherein the first vessel is a first chamber of the tank and the second vessel is a second chamber of the tank, wherein the first and second chambers are defined within the tank via a partition, wherein the partition includes an aperture to allow the flow of support medium between the first and second vessels.

20. The three-dimensional printer according to claim 19 including a plurality of partitions having a plurality of apertures, wherein the plurality of apertures enable a multidirectional flow of support medium between the first and second chambers.

21. (canceled)

22. The three-dimensional printer according to claim 2 including:
a third vessel in fluid communication with the second vessel; and
an additional pressure altering device controllable by the controller to induce a flow of control medium into the third vessel such that the production medium is lowered within the first vessel.

23. The three-dimensional printer according to claim 22, wherein a base portion of at least one wall of the second vessel includes at least one aperture to allow the flow of the control medium into the third vessel from the second vessel.

24. The three-dimensional printer according to claim 22, wherein the controller is configured to:
control the light source to cure a layer of the production medium, wherein the first layer protrudes above the production medium supported upon the support medium;
control the pressure altering device to coat the cured layer of the production medium with the production medium supported by the support medium; and then
control the additional pressure altering device to lower the supported production medium for curing the next layer.

25. The three-dimensional printer according to claim 1, wherein the pressure altering device is a drip feed assembly for dripping the support medium into the second vessel causing the production medium to rise within the first vessel.

26. The three-dimensional printer according to claim 1, wherein the pressure altering device is a source of inert gas, wherein the controller is configured to control the pressure altering device to supply at least some of the inert gas to the second vessel causing the production medium to rise within the first vessel.

27. The three-dimensional printer according to claim 1 including one or more vacuum devices.

28. The three-dimensional printer according to claim 27, wherein at least some of the one or more vacuum devices are in fluid communication with the second vessel, wherein the controller is configured to control the at least some of the one or more vacuum devices causing the support medium to rise within the second vessel.

29-30. (canceled)

31. The three dimensional printer according to claim 1, wherein the light source includes:
a displacement assembly operably controllable by the controller; and
a light emitting device operably connected to the controller and mounted to the displacement assembly;
wherein the controller is configured to actuate the displacement assembly causing the light emitting device to be displaced in one or more dimensions.

32. The three dimensional printer according to claim 1, wherein the three dimensional printer includes a further vessel having a pressurised supply of control medium contained therein and in fluid communication with the second vessel via a valve operably connected to the controller, wherein the controller is configured to actuate the valve to induce the flow of the support medium.

33-35. (canceled)

36. A method of operating a three dimensional printer according to claim 1, wherein the method includes:
partially filling the first and second vessels with a support medium;
adding the production medium to the first vessel which is supported by the support medium;
sealing the first vessel;
filling the second vessel with more support medium;
unsealing the first vessel; and
instructing the controller to control the flow of the support medium between the first and second vessels.

37. The method according to claim 36, wherein prior to instructing the controller, the method includes flushing air from the first vessel, wherein the air is replaced with an inert gas which is not air.

38. A method of operating a three dimensional printer according to claim 22, wherein the method includes:
partially filling the first and second vessels with fluid whilst the third vessel is sealed;
adding the production medium to the first vessel which is supported by the support medium;
sealing the first vessel;
filling the second vessel with more support medium;
unsealing the first vessel; and
instructing the controller to:
control the flow of the support medium between the first and second chamber to raise the production medium in the first vessel; and
control the flow of the support medium to the third vessel to lower the production medium in the first vessel.

39-41. (canceled)

42. A three-dimensional printer including:
a first vessel in fluid communication with a second vessel;
a pressure altering device;
a light source; and
a controller configured to:
control the light source to generate light directed toward a production medium contained within the first vessel to cure a portion of the production medium; and
control the pressure altering device to raise or lower the production medium within the first vessel to enable generation of layers of the cured production medium.

43-63. (canceled)

64. The three-dimensional printer according to claim 42, wherein the pressure altering device is a drip feed assembly for dripping the production medium into the second vessel causing the production medium to rise within the first vessel.

65-73. (canceled)

74. The three dimensional printer according to claim 42, wherein the controller is configured to control an intensity of the light emitted by the light source.

75. A three-dimensional printer including:
a vessel;
a pressure altering device;
a light source; and
a controller configured to:
control the light source to generate light directed toward a production medium located within the vessel to cure a portion of the production medium; and
control the pressure altering device to raise or lower the production medium within the vessel to enable generation of layers of the cured production medium.

76. A three-dimensional printer including:
a first vessel in communication with a second vessel via a passage, wherein a flowable support medium is contained within the first and second vessel;
a pressure altering device;
a light source; and
a controller configured to:
control the light source to generate light directed toward a flowable production medium supported upon the support medium located within the first vessel to cure a portion of the production medium; and
control the pressure altering device to pressurise the second vessel, thereby causing a flow of support medium between the second vessel and the first vessel enabling generation of cured layers of the production medium.
